(19) United States
(12) Patent Application Publication
(10) Pub. No.: US 2024/0195192 A1
(43) Pub. Date: Jun. 13, 2024

(54) SWITCH SYSTEMS FOR RECHARGEABLE POWER STORAGE DEVICES

(71) Applicant: SPARKION POWER ALGORITHMS LTD., Herzliya (IL)

(72) Inventor: Tomer BENTZION, Tel-Aviv (IL)

(21) Appl. No.: 18/286,270

(22) PCT Filed: Apr. 12, 2022
(86) PCT No.: PCT/IL2022/050379

§ 371 Date: Oct. 10, 2023

Related U.S. Application Data
(63) Continuation of application No. 17/467,307, filed on Sep. 6, 2021.
Application No. 17/467,307 is a continuation-in-part of application No. 17/228,924, filed on Apr. 13, 2021, now abandoned.
Application No. 17/467,307 is a continuation-in-part of application No. 17/228,924, filed on Apr. 13, 2021, now abandoned.

(30) Foreign Application Priority Data
Apr. 13, 2021 (US) 17228924
Sep. 6, 2021 (US) 17467307

(51) Int. Cl. H02J 7/00

(52) U.S. Cl. CPC H02J 7/0019; H02J 7/0071; H02J 7/0047

(57) ABSTRACT

Disclosed herein is a switch assembly electrically couplable to a rechargeable power storage device (PSD). The switch assembly includes an electrical input A, an electrical output B, and first and second conduction paths there between, passing through, and circumventing, the PSD, respectively. A positive polarity of the PSD points from A to B. The switch assembly is switchable between: (i) a state, wherein current is capable of flowing from A to B simultaneously through the first and second conduction paths but is incapable of flowing from B to A the second conduction path, (ii) a state, wherein current is capable of flowing between A and B through the second conduction path but current flow through the first conduction path is blocked, and (iii) a state, wherein current is capable of flowing between A and B through the first conduction path but current flow through the second conduction path is blocked.

### TECHNICAL FIELD

The present disclosure relates generally to systems and methods for electrochemical energy storage management.

### BACKGROUND

Since a battery pack's performance is limited by the “weakest” (electrochemical) cell, once the weakest cell is depleted, the entire stack is effectively depleted. Even for battery packs consisting of cells fabricated to the same specification (i.e. same chemistry and dimensions), the above-mentioned fact constitutes a severe limitation on performance. Crucially, cells fabricated to the same specification may differ from one another in their capacities, internal resistances, and discharge rates. Moreover, cells fabricated to the same specification may age differently, which adds an additional uncertainty factor to a battery pack's life equation.

With a looming transition to alternative energies from fossil fuels, the need for methods and systems, which will optimize the performance of battery packs and extend their life-times, grows ever more relevant.

### SUMMARY

Aspects of the disclosure, according to some embodiments thereof, relate to systems and methods for electrochemical energy storage management. More specifically, but not exclusively, aspects of the disclosure, according to some embodiments thereof, relate to switch systems and methods for rechargeable power storage devices (PSDs).

The present application discloses systems and methods for managing an array of PSDs (e.g. electrochemical cells, battery modules, battery packs)—which overcome the limitations of the weakest PSDs (e.g. the cells with the lowest capacities or highest resistances, or a combination of capacity and resistance that renders them “weakest”) in the array. This is achieved via an infrastructure that is capable of reconfiguring such that the weakest PSDs may be “sidelined” and, if necessary, compensated for. Key to this is the possibility of safely enabling and circumventing each PSD when powering (e.g. charging) a load, while avoiding, or at least minimizing, risk of short-circuit, and maintaining a fixed, or substantially fixed, current throughout the transition from an enabled state, wherein the PSD is discharging, to a disabled state, wherein the PSD is circumvented (i.e. bypassed), and vice-versa (so that dips in the current, which may potentially damage the powered load, are avoided). Advantageously, the present application discloses such a switch system (i.e. with the above-listed features). The switch system may include one or more switch assemblies, each associated with respective PSD in the array, and a controller.

An array, including the disclosed switch system, may further include monitoring equipment, and a power conversion systems (PCSs), associated with the controller. The controller may be configured to identify when a weak PSD is close to being depleted (when discharging) or close to being saturated (i.e. fully charged, when charging), based on data received thereby from the monitoring equipment, and accordingly instruct the respective switch assembly to circumvent the PSD. Further, the option of circumventing PSDs (combined with monitoring thereof) may be utilized to prevent occurrence of over-voltage and under-voltage states without disabling other PSDs or otherwise disrupting the operation thereof. More specifically, the controller may be configured to control operation of the PCS and selectively functionally associate the PSDs with PCS. The PCS may have AC-DC inversion capabilities and/or DC-DC conversion capabilities. According to some embodiments, the AC-DC inversion capabilities may be bidirectional. According to some embodiments, the PCS may include one or more bidirectional inverters and/or one or more DC-DC converters or chargers (not shown).

Each of the DC-DC chargers may have a dynamic and reactive input voltage, based on the number, respective output voltages, and the configuration of the enabled PSDs connected thereto. Advantageously, this allows charging and/or powering different DC loads, and, in particular, rechargeable (DC) loads, which may differ significantly from one another in their input voltages. AC loads may also be charged and/or charged, using suitable DC-to-AC circuitry, which may be included in the PCS.

According to some embodiments, each switch assembly of the switch system includes a plurality of SPST and/or SPDT switches, which may be realized by contactors (and/or relays). Use of contactors (and/or relays) offers the following advantages:
low resistance to passage of current through the switch;
ease of maintenance: the switches allow to galvanically disconnect each PSD from the other PSDs in the array, which allows for safe and rapid removal of a PSD also while other PSDs are enabled;
absence of, or at least reduction in, leakage currents; and
robustness to various modes of failure due to voltage and current spikes.

As a further advantage, the disclosed systems and methods allow for repurposing of discarded rechargeable batteries, pertinently, retired electric vehicle (EV) batteries.

Thus, according to an aspect of some embodiments, there is provided a switch system for one or more rechargeable power storage devices (PSDs). The switch system includes a controller and a switch assembly, functionally associated with the controller. The switch assembly is electrically couplable to a PSD so as to constitute together therewith a switched-equipped PSD, including an electrical input (EI), an electrical output (EO), a first conduction path (FCP), and at least one additional conduction path (ACP) between the EI and the EO, such that the FCP passes through the PSD, with a positive polarity of the PSD pointing from the EI to the EO, and each of the at least one ACP circumvents the PSD. The switch assembly is switchable by the controller at least between:
a first assembly state Q₁, wherein current is capable of flowing from the EI to the EO simultaneously through the FCP and one or more of the at least one ACP but is incapable of flowing from the EO to the EI through any of the at least one ACP, so that possibility of short circuit due to self-discharge of the PSD is eliminated;
a second assembly state Q₂, wherein current is capable of flowing between the EI and the EO through one or more of the at least one ACP but current flow through the FCP is blocked; and
a third assembly state Q₃, wherein current is capable of flowing between the EI and the EO through the FCP but current flow through each of the at least one ACP is blocked, or an alternative third assembly state Q₃′, wherein current is capable of flowing from the EI to the EO through one or more of the at least one ACP but is incapable of flowing from the EO to the EI through any one thereof, and current flow through the FCP is blocked.

According to some embodiments, the switch assembly is further switchable by the controller to a fourth state Q₀, wherein current flow between the EI and the EO is blocked.

According to some embodiments, wherein the switch assembly is switchable to the third assembly state Q₃, the switch assembly includes a first switching module and a second switching module. The first switching module is serially-connected to the PSD and is positioned together therewith on a first line extending from the EI to the EO, which corresponds to the FCP. The second switching module is positioned on a second line extending from the EI to the EO, which corresponds to the at least one ACP. Each of the switching modules is switchable by the controller between a module state S_{b}, in which current is capable of bidirectional flow therethrough (i.e. both in the EI-to-the EO direction and in the EO-to-the EI direction), and a module state S₀, in which current flow therethrough is blocked. The second switching module is additionally switchable by the controller to a module state Sₚ, in which current is only capable of flowing therethrough from the EI to the EO. When the first switching module is in module the S_{b} and the second switching module is in the module state Sₚ, the switch assembly is in the first assembly state Q₁. When the first switching module is in the S₀ and the second switching module is in the module state S_{b}, the switch assembly is in the second assembly state Q₂. When the first switching module is in the module state S₀ and the second switching module is in the state Sₚ, the switch assembly is in the third assembly state Q₃.

According to some embodiments, wherein the switch assembly is switchable to the alternative third assembly state Q₃′, the switch assembly includes a first switching module and a second switching module. The first switching module is serially-connected to the PSD and is positioned together therewith on a first line extending from the EI to the EO, which and corresponds to the FCP. The second switching module is positioned on a second line extending from the EI to the EO, and which corresponds to the at least one ACP. Each of the switching modules is switchable by the controller to a module state S_{b}, in which current is capable of bidirectional flow therethrough (i.e. both in the EI-to-the EO direction and in the EO-to-the EI direction). The first switching module is additionally switchable by the controller to a module state S₀, in which current flow therethrough is blocked. The second switching module is additionally switchable by the controller to a module state Sₚ, in which current is only capable of flowing therethrough in the EI-to-the EO direction. When the first switching module is in the module state S_{b} and the second switching module is in the module state Sₚ, the switch assembly is in the first assembly state Q₁. When the first switching module is in the module state S₀ and the second switching module is in the module state S_{b}, the switch assembly is in the second assembly state Q₂. When the first switching module is in the module state S₀ and the second switching module is in the state Sₚ, the switch assembly is in the alternative third assembly state Q₃′.

According to some embodiments, the switch system is configured to preclude possibility of the two switching modules simultaneously each being in the module state S_{b}.

According to some embodiments, the second switching module is connected in parallel to the PSD and the first switching module.

According to some embodiments, wherein the switch assembly is switchable to the third assembly state Q₃, the controller is further configured to (i) circumvent the PSD, starting from an initial state wherein the PSD is discharging, by switching the switching modules from (S_{b}, S₀) to (S₀, S_{b}) via (S_{b}, Sₚ), and (ii) enable the PSD to discharge, by switching the switching modules from (S₀, S_{b}) to (S_{b}, S₀) via (S_{b}, Sₚ). A first entry in each pair of brackets denotes a module state of the first switching module and a second entry in each pair of brackets denotes a module state of the second switching module.

According to some embodiments, wherein the switch assembly is switchable to the third assembly state Q₃, the controller is further configured to (i) disable the PSD, when charging, by diverting current from the first line to the second line by switching the switching modules directly from (S_{b}, S₀) to (S₀, S_{b}), and (ii) enable the PSD to charge, by diverting current from the second line to the first line by switching the switching modules directly from (S₀, S_{b}) to (S_{b}, S₀).

According to some embodiments, wherein the switch assembly is switchable to the third assembly state Q₃, the switch system is further configured to in disabling the PSD, when charging, and/or in enabling the PSD to charge, switch the switching modules from (S₀, S_{b}) to (S_{b}, S₀) through the state (S₀, S₀) or otherwise temporarily switch off the current. According to some embodiments, wherein the switch assembly is switchable to the alternative third assembly state Q₃′, the controller is further configured to (i) circumvent the PSD, starting from an initial state wherein the PSD is discharging, by switching the switching modules from (S_{b}, Sₚ) to (S₀, S_{b}) via (S₀, Sₚ), and (ii) enable the PSD to discharge, by switching the switching modules from (S₀, Sₚ) to (S_{b}, Sₚ) via (S_{b}, S₀). A first entry in each pair of brackets denotes a module state of the first switching module and a second entry in each pair of brackets denotes a module state of the second switching module.

According to some embodiments, the second switching module includes a switching unit, a diode, a second switching module input, and a second switching module output. The second switching module input is positioned between the electrical input and the switching unit, adjacently to the switching unit. A third line and a fourth line extend in the EI-to-EO direction from the switching unit and converge to the second line at the second switching module output, which forms a three-way junction. The diode is mounted on the fourth line and is configured to prevent current flow in the EO-to-EI direction. The switching unit is switchable at least between a (i) two-way conduction state M_{b}, in which the electrical input is electrically coupled to the third line via the switching unit, and (ii) a one-way conduction state Mₚ, in which the electrical input is electrically coupled to the fourth line via the switching unit and electrically decoupled from the third line.

According to some embodiments, wherein the switching assembly is switchable to the third assembly state Q₃, the switching unit is additionally switchable to a no-conduction state M₀, in which the switching unit electrically decouples the electrical input from both the third line and the fourth line.

According to some embodiments, wherein the switching assembly is switchable to the alternative third assembly state Q₃′, the switching unit is or includes a SPDT switch configured to controllably electrically couple the electrical input to either the third line or the fourth line. According to some such embodiments, the SPDT switch is or includes a contactor.

According to some embodiments, wherein the switching assembly is switchable to the third assembly state Q₃, the switching unit is or includes a first SPST switch mounted on the third line and a second SPST switch mounted on the fourth line. According to some such embodiments, each of the SPST switches is or includes a contactor.

According to some embodiments, the controller is configured to synchronize the switching of the first and second switching modules, such that, in disabling the PSD, when charging, and in enabling the PSD to charge, the switching modules are not transitioned through the joint state (S_{b}, S_{b}).

According to some embodiments, wherein the switch assembly is switchable to the third assembly state Q₃, in disabling the PSD, when discharging, and in enabling the PSD to discharge, a duration spent in the state (S_{b}, Sₚ) is at least about a time it takes for the switching modules to switch between module states.

According to some embodiments, the switch assembly includes a first switching module and a second switching module. The first switching module is serially-connected to the PSD and is positioned together therewith on a first line extending from the EI to the EO, which corresponds to the FCP. The second switching module is positioned on a second line extending from the EI to the EO, which corresponds to a first conduction path of the at least one ACP (i.e. a second conduction path). A third line extends from the second switching module to the first switching module and has a mounted thereon a diode configured to prevent current flow through the third line from the first switching module to the second switching module. A line segment of the second line, which extends from the electrical input to the second switching module, the third line, and a line segment of the first line, which extends from the first switching module to the electrical output, jointly define a second conduction path of the at least one ACP (i.e. a third conduction path). The first switching module is switchable by the controller to a module state S_{b}′, in which current is capable of flowing via the first line both from the EI to the EO and from the EO to the EI, and to a module state S₀′, in which current flow via the first line both from the EI to the EO and from the EO to the EI is blocked. The second switching module is switchable by the controller to a module state S_{b}″, in which current is capable of flowing via the second line both from the EI to the EO and from the EO to the EI, and a module state Sₚ″, in which current is capable of flowing from the EI to the EO but not vice-versa via the second conduction path of the at least one ACP.

According to some embodiments, the switch system is configured to preclude possibility of the two switching modules being simultaneously in the module states S_{b}′ and S_{b}″, respectively.

According to some embodiments, when the first switching module is in module the S_{b}′ and the second switching module is in the module state Sₚ″, the switch assembly is in the first assembly state Q₁. When the first switching module is in the S₀′ and the second switching module is in the module state S_{b}″, the switch assembly is in the second assembly state Q₂. When the first switching module is in the module state S₀′ and the second switching module is in the module state Sₚ″, the switch assembly is in the alternative third assembly state Q₃′.

According to some embodiments, wherein the switch assembly is switchable to the alternative third assembly state Q₃′, the controller is further configured to (i) circumvent the PSD, starting from an initial circuit state wherein the PSD is discharging, by switching the switching modules from (S_{b}′, Sₚ″) to (S₀′, S_{b}″) via (S₀′, Sₚ″), and (ii) enable the PSD to discharge, by switching the switching modules from (S₀′, S_{b}″) to (S_{b}′, Sₚ″) via (S₀′, Sₚ″). A first entry in each pair of brackets denotes a module state of the first switching module and a second entry in each pair of brackets denotes a module state of the second switching module.

According to some embodiments, the second switching module is additionally switchable to a module state S₀″, in which current flow via the second line both from the EI to the EO and from the EO to the EI is blocked.

According to some embodiments, when the first switching module is in module the S_{b}′ and the second switching module is in the module state Sₚ″, the switch assembly is in the first assembly state Q₁. When the first switching module is in the S₀′ and the second switching module is in the module state S_{b}″, the switch assembly is in the second assembly state Q₂. When the first switching module is in the module state S_{b}′ and the second switching module is in the state S₀″, the switch assembly is in the third assembly state Q₃.

According to some embodiments, wherein the switch assembly is switchable to the third assembly state Q₃, the controller is further configured to (i) circumvent the PSD, starting from an initial circuit state wherein the PSD is discharging, by switching the switching modules from (S_{b}′, S₀″) to (S₀′, S_{b}″) via (S_{b}′, Sₚ″), and (ii) enable the PSD to discharge, by switching the switching modules from (S₀′, S_{b}″) to (S_{b}′, S₀″) via (S_{b}′, Sₚ″). A first entry in each pair of brackets denotes a module state of the first switching module and a second entry in each pair of brackets denotes a module state of the second switching module.

According to some embodiments, wherein the switch assembly is switchable to the third assembly state Q₃, the controller is further configured to (i) disable the PSD, when charging, by diverting current from the first line to the second line by switching the switching modules directly from (S_{b}′, S₀″) to (S₀′, S_{b}″), and (ii) enable the PSD to charge, by diverting current from the second line to the first line by switching the switching modules directly from (S₀′, S_{b}″) to (S_{b}′, S₀″).

According to some embodiments, wherein the switch assembly is switchable to the third assembly state Q₃, the switch system is further configured to in disabling the PSD, when charging, and/or in enabling the PSD to charge, switch the switching modules from (S₀′, S_{b}″) to (S_{b}′, S₀″) via the state (S₀′, S₀″) or otherwise temporarily switch off the current.

According to some embodiments, the controller is configured to synchronize the switching of the first and second switching modules, such that, in disabling the PSD, when charging, and in enabling the PSD to charge, the switching modules are not transitioned via the state (S_{b}′, S_{b}″).

According to some embodiments, wherein the switch assembly is switchable to the third assembly state Q₃, in disabling the PSD, when discharging, and in enabling the PSD to discharge, a duration spent in the state (S_{b}′, Sₚ″) is at least about a time it takes for the switching modules to switch between module states.

According to some embodiments, the PSD includes a rechargeable battery pack.

According to some embodiments, the battery pack includes a plurality of batteries connected, or connectable, to one another in series, parallel, and/or a combination thereof.

According to some embodiments, the battery pack is an electric vehicle (EV) battery pack.

According to some embodiments, the EV battery pack is a second-life EV battery pack.

According to some embodiments, one or more of the PSDs includes a supercapacitor.

According to some embodiments, the switch system further includes monitoring equipment including one or more of an ammeter, a voltmeter, an ohmmeter, and/or capacitance meter. The monitoring equipment is configured to monitor a state-of-charge (SoC) and/or remaining capacity, of the PSD, and to send to the monitored SoC and/or the monitored remaining capacity, to the controller. The controller is configured to, during discharging of the PSD, instruct the switch assembly to disable the PSD when the PSD becomes depleted or sufficiently near depleted. The controller is configured to, during charging of the PSD, instruct the switch assembly to disable the PSD when the PSD becomes saturated or sufficiently near saturated.

According to some embodiments, the monitoring equipment further includes one or more of a thermometer, configured to measure a temperature of the PSD, and/or a pressure meter, configured to measure a pressure within the PSD. The monitoring equipment is configured to send the measured temperature and/or the measured pressure to the controller. The controller is configured to instruct the switch assembly to disable the PSD when the measured temperature exceeds a threshold temperature and/or when the measured pressure exceeds a threshold pressure.

According to an aspect of some embodiments, there is provided a switch-equipped PSD including a PSD and a switch system as described above.

According to an aspect of some embodiments, there is provided a power management system (PMS) for controlling and regulating charging and discharging of an array of rechargeable PSDs. The PMS includes a plurality of serially connectable PSDs and switch systems as described above. Each of the switch systems is associated with a respective one of the PSDs. The PMS further includes monitoring equipment configured to monitor at least SoCs and/or remaining capacities of the PSDs in the array. The controller of each switch system is configured to switch the respective switching assembly between the respective assembly states thereof based at least on the monitored SoCs and/or remaining capacities of the respective PSD.

According to some embodiments, the PMS controllers of each of the switch systems constitute a single common controller.

According to some embodiments, the monitoring equipment is further configured to monitor, at least periodically, charge capacities of the PSDs. The controller is configured to switch each of the switching assemblies between the respective assembly states thereof taking into account the monitored charge capacities of all of the PSDs.

According to some embodiments, the PMS is connectable to a power grid, and configured to allow selectively charging each of the PSDs from the power grid.

According to some embodiments, the controller is configured to allow charging a first group of PSDs while simultaneously discharging a second group of PSDs.

According to some embodiments, the PMS further includes infrastructure whereon the PSDs are installed or installable.

According to some embodiments, the infrastructure is modular so as to allow adding one or more additional PSDs to the array.

According to some embodiments, the PMS is configured to allow replacing one or more of the PSDs in the array while one or more of the other PSDs in the array are charging and/or discharging.

According to some embodiments, the PSDs in the array include a plurality of battery packs of EVs.

According to some embodiments, the PMS further includes a PCS, or at least a DC-DC charger, connectable to the array, so as to allow charging rechargeable loads over a range of voltages.

According to some embodiments, the DC-DC charger is bidirectional, so as to allow discharging a rechargeable load onto one or more PSDs in the array.

According to some embodiments, the PCS includes a plurality of DC-DC chargers, so as to allow simultaneously charging a plurality of rechargeable loads characterized by different charging voltages.

According to some embodiments, the PCS further includes one or more bidirectional inverters, so as to allow charging the PSDs using an (external) AC power source, as well as powering one or more AC loads.

According to some embodiments, the controller is configured to determine, based on charge requirements of one or more rechargeable loads, which of the PSDs is or are to be employed to charge the one or more rechargeable loads, such that one or more of a power consumption, charging time, and electricity cost is minimized, or substantially minimized (e.g. to within 5%, 10%, or 20% above the actual minimum), and/or a desired trade-off there between is achieved.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1 is a combined block-circuit diagram of a switch system for a rechargeable power storage device (PSD), the switch system including a controller and a switching assembly, according to some embodiments;

FIG. 2 is a combined block-circuit diagram of a switch system for a rechargeable PSD, which corresponds to specific embodiments to the switch system of FIG. 1, wherein the switch assembly includes a pair of switching modules connected in parallel;

FIG. 3 is a combined block-circuit diagram of specific embodiments of the switch system of FIG. 2;

FIG. 4 is a combined block-circuit diagram of a switch system for a rechargeable PSD, which corresponds to specific embodiments to the switch system of FIG. 1, wherein the switch assembly includes a pair of switching modules;

FIG. 5 to 7 are a combined block-circuit diagrams of three switch systems, respectively, for a rechargeable PSD, each of which corresponds to specific embodiments of the switch system of FIG. 3;

FIGS. 8 and 9 are a combined block-circuit diagrams of three switch systems, respectively, for a rechargeable PSD, each of which corresponds to specific embodiments of the switch system of FIG. 4;

FIGS. 10A to 10E depict successive stages in switching of the switch assembly of FIG. 5 from an initial state wherein the PSD is discharging to a final state wherein the PSD is bypassed, according to some embodiments;

FIGS. 10F and 10G depict switching of the switch assembly of FIG. 5 from an initial state wherein the PSD is bypassed to a final state wherein the PSD is charging, according to some embodiments;

FIGS. 11A to 11C depict successive stages in switching of the switching modules of FIG. 8 from an initial state wherein the PSD is discharging to a final state wherein the PSD is bypassed, according to some embodiments;

FIGS. 11D and 11E depict successive stages in switching of the switching modules of FIG. 8 from an initial state wherein the PSD is bypassed to a final state wherein the PSD is charging, according to some embodiments;

FIG. 12 is a block diagram of an energy storage including a PSD array of rechargeable PSDs and a power management system (PMS) configured to control and regulate charging and discharging of the PSDs in the array via a switching assembly including a plurality of switch assembly of FIG. 1, according to some embodiments;

FIG. 13 is a circuit diagram of a plurality of serially connected switched equipped PSDs, according to some embodiments;

FIG. 14A presents a flowchart of a method for bypassing a switched-equipped PSD, according to some embodiments; and

FIG. 14B presents a flowchart of a method for enabling a switched-equipped PSD, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

Referring to the figures, optional elements/components may appear within boxes delineated by a dashed line. In flowcharts, operations on a system are represented by sharp-cornered rectangles, while states of the system (whether initial, intermediate, or final states) are represented by round-cornered rectangles.

As used herein, the verb “to circumvent” is used in the meaning of “to bypass”. Accordingly, the verbs “to circumvent” and “to bypass” are used interchangeably, as are derivatives thereof.

As used herein, the term “SPST switch” (short for “single pole single throw switch”) refers to an electrical switch, which is switchable between (i) a first switch-state, wherein current may be conducted bidirectionally therethrough (i.e. in either of two opposite directions), and (ii) a second switch-state, wherein current flow through the switch is blocked. Contactors and relays, switchable between being closed (i.e. switched on) and open, provide examples of SPST switches. These may include electromechanical relays, solid state relays, DC relays. AC relays, and the like. As used herein, the term “SPST switch” is to be understood in an expansive manner and also covers cases wherein the switch is constructed from two or more switches, and/or wherein the switch may, in principle, be switched to one or more additional states, which are not used or deliberately blocked from use. Accordingly, a “SPST switch” may be realized, for example, by two field-effect transistors (FETs), such that the drain of the first FET is directly connected to the drain of the second FET. A “SPST switch” may also be realized by a pair of bipolar junction transistors (BJTs) or a pair of insulated-gate bipolar transistors (IGBTs), which are connected in parallel and which, when switched on, conduct current in opposite directions.

As used herein, the terms “SPDT switch” (short for “single pole double throw switch”) or equivalently “three-way switch” refers to an electrical switch, which includes a first (input), second (output), and third (output) terminals, and which is switchable between (i) a first switch-state, wherein current may be conducted bidirectionally therethrough exclusively between the first terminal and the second terminal, and a second switch-state, wherein current may be conducted bidirectionally therethrough exclusively between the first terminal and the third terminal. Contactors and relays, switchable between closing a first electrical and closing a second electrical path, provide examples of SPDT switches. These may include electromechanical relays, solid state relays, DC relays. AC relays, and the like. The term “SPDT switch” is to be understood in an expansive manner and also covers cases wherein the switch is constructed from two or more switches, and/or wherein the switch may, in principle, be switched one or more additional states, which are not used or deliberately blocked from use. Accordingly, a “SPDT switch” may be realized by a three-way junction including an input line and a pair of output lines on which a pair of bipolar junction transistors (BJTs) or a pair of insulated-gate bipolar transistors (IGBTs) are respectively mounted, and which when switched on, conduct current away from the junction.

### Switch Systems

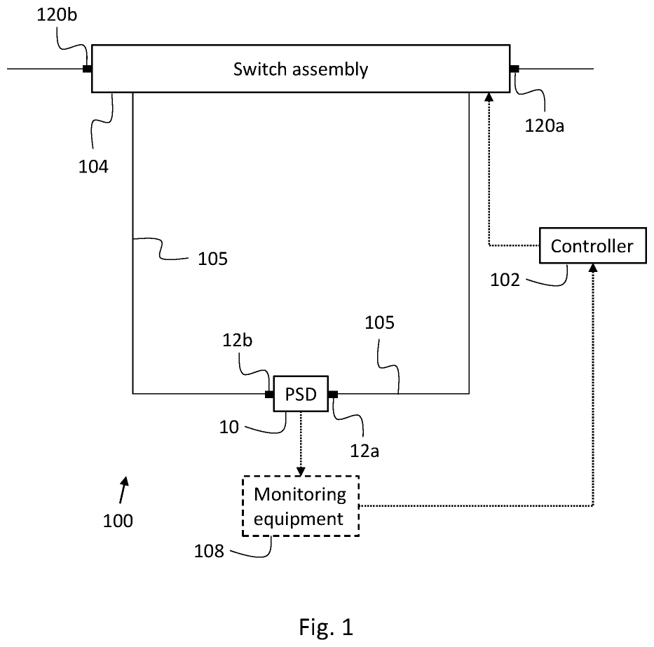

FIG. 1 is a combined block-circuit diagram of a switch system 100 for one or more rechargeable power storage devices (PSDs), according to some embodiments. Switch system 100 includes a controller 102 and a switch assembly 104, which is functionally associated with controller 102. According to some embodiments, switch system 100 may further include monitoring equipment 108, which is functionally associated with controller 102.

Also shown in FIG. 1 is a rechargeable PSD 10. PSD 10 is an electrochemical energy storage device, which is rechargeable. According to some embodiments, PSD 10 may be an electrochemical cell (such as a lithium ion battery), a battery module, a battery pack, or a supercapacitor, as further detailed below.

Typically, an electrochemical cell includes an anode(s) and a cathode(s) with current collectors affixed thereto. The electrochemical cell may include a soft or hard package (e.g. a pouch, a prismatic or cylindrical package). As used herein, according to some embodiments, the terms “electrochemical cell” and “battery” may be used interchangeably. As used herein, a “battery module” may include a plurality of electrochemical cells. A “battery pack” may include one or more battery modules.

Rechargeable electrochemical energy storage devices, such as batteries and supercapacitors, come in a large variety of shapes and forms (cylindrical, prismatic, pouch, etc.) and types (chemistries). Examples of chemistries include lithium cobalt oxide (LiCoO₂), lithium iron phosphate (LFP), lithium manganese oxide (LMO), lithium nickel manganese cobalt oxide (NMC), lithium nickel cobalt aluminum oxide (NCA), and lithium titanate oxide (LTO). Other common rechargeable cell chemistries include lead acid, nickel-cadmium (NiCad), and nickel metal hydride (NiMH).

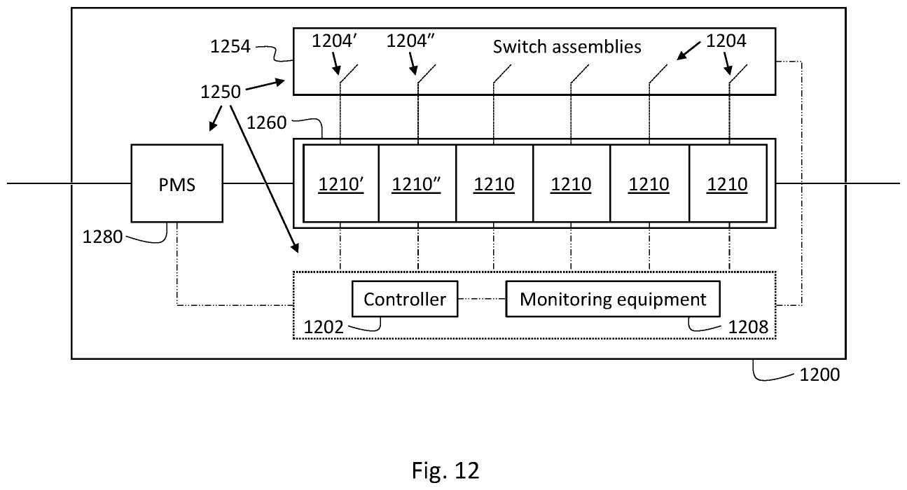

All of the above options (i.e. shapes, forms, and chemistries) are covered by the scope of the disclosure. That is, each option represents separate embodiments of PSD 10. Further, disclosed PSD arrays, such as the PSD array depicted in FIG. 12, are not limited to including a single type of PSDs. That is, different PSDs in the disclosed PSD arrays, according to some embodiments, may differ from one another in shape, form, and chemistry. Different combinations of the above options (e.g. a LiCoO₂ battery and NiCad battery in a two-cell array) correspond to separate embodiments.

Switch assembly 104 is electrically couplable to PSD 10 so as to constitute together therewith a switched-equipped PSD. Switch system 100 includes an electrical input 120a, an electrical output 120b, and a first conduction path 105 (e.g. an electrical line) between electrical input 120a and electrical output 120b, and at least one additional conduction path (e.g. one or more additional electrical lines; not shown) between electrical input 120a and electrical output 120b. First conduction path 105 path passes through PSD 10, with a positive polarity of PSD 10 pointing from input to output (i.e. from electrical input 120a to electrical output 120b). Each of the at least one additional conduction path (ACP) circumvents PSD 10. According to some embodiments, one or more the at least one ACP may partially overlap with first conduction path 105, so long as PSD 10 is bypassed (as shown, for example, in FIGS. 8 and 9). According to some embodiments, two or more of the at least one ACP (in embodiments wherein the at least one ACP includes a plurality of conduction paths) may partially overlap. Also indicated in FIG. 1 are a negative terminal 12a and a positive terminal 12b of PSD 10.

Switch system 100 is configured such that discharge of PSD 10 onto itself (and consequent short circuit) is precluded. That is, switch system 100 is configured to preclude possibility of current being conducted by PSD 10 clockwise in a loop—i.e. from input to output (from electrical input 120a to electrical output 120b) via the first conduction path and back from output to input (from electrical output 120b to electrical input 120a) via any of the at least one ACP—and, as such, constitutes a central safety feature of switch system 100. Hence, when current flow from input to output through the first conduction path is possible, current flow from output to input through any of the at least one ACP is blocked.

Switch system 100 is configured to effect a “seamless transition” from an initial circuit state, wherein PSD 10 is discharging, to a final circuit state, wherein PSD 10 is bypassed, and vice-versa. As used herein, the term “seamless transition” refers to changing the state of a circuit from an initial circuit state to a final circuit state, such that during the transition there between (and through any intermediate circuit states), there is always a closed conduction path in the circuit for the current to flow through. Consequently, when PSD 10 forms part of a PSD array, as depicted in FIG. 12, for example, transitions of PSD 10 from discharge to bypass and vice-versa are not accompanied by sharp changes in current and/or voltage, which may be detrimental to an external load that is simultaneously powered by the PSD array. According to some embodiments, switch system 100 may additionally be configured to effect a “seamless transition” from an initial circuit state, wherein PSD 10 is being charged, to a final circuit state, wherein PSD 10 is bypassed, and vice-versa.

According to some embodiments, switch assembly 104 is switchable by controller 102 between three assembly states:
In a first assembly state Q₁, current is capable of flowing from input to output and vice-versa (i.e. from output to input) through first conduction path 105, and from input to output through one or more of the at least one ACP but is incapable of flowing from output to input through any (i.e. any one) of the at least one ACP, so that possibility of short circuit due to discharge of the PSD onto itself is eliminated.
In a second assembly state Q₂, current is capable of flowing from input to output and vice-versa through one or more of the at least one ACP but is blocked from flowing from input to output and vice-versa through first conduction path 105 (and, in particular, through PSD 10).
In a third assembly state Q₃, current is capable of flowing from input to output and vice-versa through first conduction path 105 but is blocked from flowing from input to output and vice-versa through any of the at least one ACP.

In such embodiments, in order to switch switch system 100 from an initial circuit state wherein PSD 10 is discharging to a final circuit state wherein PSD 10 is bypassed and current flows from input to output, controller 102 may be configured to switch switch assembly 104 through the sequence of assembly states Q₃→Q₁→Q₂ (i.e. first Q₃ to Q₁ and then Q₁ to Q₂). Due to the transition through the first assembly state Q₁, the transition from discharge to bypass is seamless. In order to switch switch system 100 from an initial circuit state wherein PSD 10 is bypassed, and current flows from input to output, to a final circuit state wherein PSD 10 is discharging, controller 102 may be configured to switch switch assembly 104 through the reverse sequence of assembly states (i.e. Q₂→Q₁→Q₃). The transition from bypass to discharge is thus also seamless. Further, according to some such embodiments, in order to switch switch system 100 from an initial circuit state wherein PSD 10 is being charged to a final circuit state wherein PSD 10 is bypassed and current flows from output to input, controller 102 may be configured to switch switch assembly 104 directly from the third assembly state Q₃ to the second assembly state Q₂. In order to switch switch system 100 from an initial circuit state wherein PSD 10 is bypassed, and current flows from output to input, to a final circuit state wherein PSD 10 is being charged, controller 102 may be configured to switch switch assembly 104 directly from the second assembly state Q₂ to the third assembly state Q₃.

According to some embodiments, in addition to the assembly states Q₁, Q₂, and Q₃, switch assembly 104 may further be switchable by controller 102 to a fourth assembly state Q₀, wherein current is flow through each of the conduction paths (i.e. first conduction path 105 and each of the at least one ACP) is blocked.

According to some alternative embodiments, switch assembly 104 is switchable by controller 102 between the first assembly state Q₁, the second assembly state Q₂, and an alternative third assembly state Q₃′. In the alternative third assembly state Q₃′, current is capable of flowing from input to output through one or more of the at least one ACP but is incapable of flowing from output to input through any one of the at least one ACP and is blocked from flowing from input to output and vice-versa through first conduction path 105.

In such embodiments, in order to switch switch system 100 from an initial circuit state wherein PSD 10 is discharging to a final circuit state wherein PSD 10 is bypassed and current flows from input to output, controller 102 may be configured to switch switch assembly 104 through the sequence of assembly states Q₁→Q₃′→Q₂. Since in the first assembly state Q₁ current is, in principle, capable of flowing from input to output both through first conduction path 105 and through one or more of the at least one ACP, the transition from discharge to bypass is seamless. The transition via the alternative third assembly state Q₃′ eliminates possibility of short circuit due to discharge of PSD 10 onto itself. In order to switch switch system 100 from an initial circuit state wherein PSD 10 is bypassed, and current flows from input to output, to a final circuit state wherein PSD 10 is discharging, controller 102 may be configured to switch switch assembly 104 through the reverse sequence of assembly states (i.e. Q₂→Q₃′→Q₁). The transition from bypass to discharge is thus also seamless. Further, according to some such embodiments, in order to switch switch system 100 from an initial circuit state wherein PSD 10 is being charged to a final circuit state wherein PSD 10 is bypassed and current flows from output to input, controller 102 may be configured to switch switch assembly 104 directly from the alternative third assembly state Q₃′ to the second assembly state Q₂. In order to switch switch system 100 from an initial circuit state wherein PSD 10 is bypassed, and current flows from output to input, to a final circuit state wherein PSD 10 is being charged, controller 102 may be configured to switch switch assembly 104 directly from the second assembly state Q₂ to the alternative third assembly state Q₃′.

According to some embodiments, wherein switch assembly 104 is switchable to the third state Q₃, switch system 100 may be configured to allow safe removal of PSD 10 (i.e. disconnection from first conduction path 105) when switch assembly 104 is in the state Q₂—that is, when PSD 10 is bypassed (or more generally disabled). Thus, in embodiments including a plurality of PSD 10, which are serially connected and are each associated with a respective switch assembly 104, each of the PSDs may be removed—e.g. for maintenance purposes, or if damaged, or otherwise underperforming, in order to be replaced—without necessitating bypassing (or otherwise disabling) of any of the other PSDs. Hence, charging or discharging of the other PSDs is advantageously not interrupted. Similarly, according to some embodiments, wherein switch assembly 104 is switchable to the alternative third assembly state Q₃′, switch system 100 may be configured to allow safe removal of PSD 10 when switch assembly 104 is in the assembly state Q₂ or Q₃′—that is, when PSD 10 is bypassed (or more generally disabled).

According to some embodiments, PSD 10 is an electric vehicle (EV) cell, battery module, or/and battery pack, for example, an electric passenger car battery pack, an electric motorcycle battery pack, an electric van battery pack, or an electric truck battery pack. According to some embodiments, PSD 10 is a second-life EV battery pack.

Monitoring equipment 108 may include monitoring electronics, such as an ammeter, a voltmeter, an ohmmeter, a capacitance meter, and/or the like. According to some embodiments, monitoring equipment 108 may further include a thermometer, and/or a pressure meter. Monitoring equipment 108 is configured to monitor one or more electrical parameters, and optionally physical parameters, of PSD 10, and to send the monitored values to controller 102. More precisely, from monitored values obtained by monitoring equipment 108, and sent to controller 102, values of one or more electrical parameters, and optionally one or more physical parameters, may be derived (unless measured directly by monitoring equipment 108, in which case no derivation is required). The electrical parameters may include one or more of a state-of-charge (SoC), a remaining capacity, a resistance, a capacitance, and a charge and/or discharge rate of PSD 10, and/or a voltage there across (i.e. the potential difference between the terminals of PSD 10). The physical parameters may include one or more of a temperature of PSD 10 (e.g. temperature within PSD 10) and a pressure within PSD 10.

According to some embodiments, controller 102 may include a processor and a memory (not shown). The processor may be configured to decide when to bypass or enable PSD 10 based on monitoring data received from monitoring equipment 108. For example, the processor may be configured to determine a SoC of PSD 10, and/or a remaining capacity thereof, and accordingly decide to bypass PSD 10 (e.g. when PSD 10 is discharging and is nearly depleted or when PSD 10 is charging and is nearly fully charged). According to some embodiments, and as elaborated on below in the description of FIG. 12, wherein PSD 10 forms part of an array of PSDs (which are all functionally associated with controller 102), controller 102 may be configured to determine whether to disable (e.g. circumvent) or enable PSD 10, and more generally each of the PSDs, so as to power, for instance, most efficiently an (external) load (whether DC or AC) and/or charge most quickly an (external) rechargeable load.

According to some embodiments, controller 102 may be configured to instruct switch assembly 104 to bypass PSD 10 when the voltage across PSD 10 (as measured by monitoring equipment 108) exceeds an upper threshold and/or drops below a lower threshold. Similarly, according to some embodiments, controller 102 may be configured to instruct switch assembly 104 to bypass PSD 10 when the temperature of PSD 10 (as measured by monitoring equipment 108) exceeds a threshold temperature and/or the pressure within PSD 10 (as measured by monitoring equipment 108) exceeds a threshold pressure.

According to some embodiments, controller 102 may further include a timer (not shown; which may be part of the processor) allowing to order the switching operations (i.e. the transition between assembly states) specified in the description above. In particular, in the disabling of PSD 10 when charging, the timer may be used to synchronize direct switching of switch assembly 104 to the second assembly state Q₂ from (i) the third assembly state Q₃ (in some embodiments wherein switch assembly 104 is switchable thereto) or (ii) the alternative third assembly state Q₃′ (in some alternative embodiments wherein switch assembly 104 is switchable thereto). Further, in the enabling of PSD 10 to charge, the timer may be used to synchronize direct switching of switch assembly 104 from the second assembly state Q₂ to (i) the third assembly state Q₃ (in some embodiments wherein switch assembly 104 is switchable thereto) or (ii) the alternative third assembly state Q₃′ (in some alternative embodiments wherein switch assembly 104 is switchable thereto). Further, the timer may be used in computing the capacities of the PSDs.

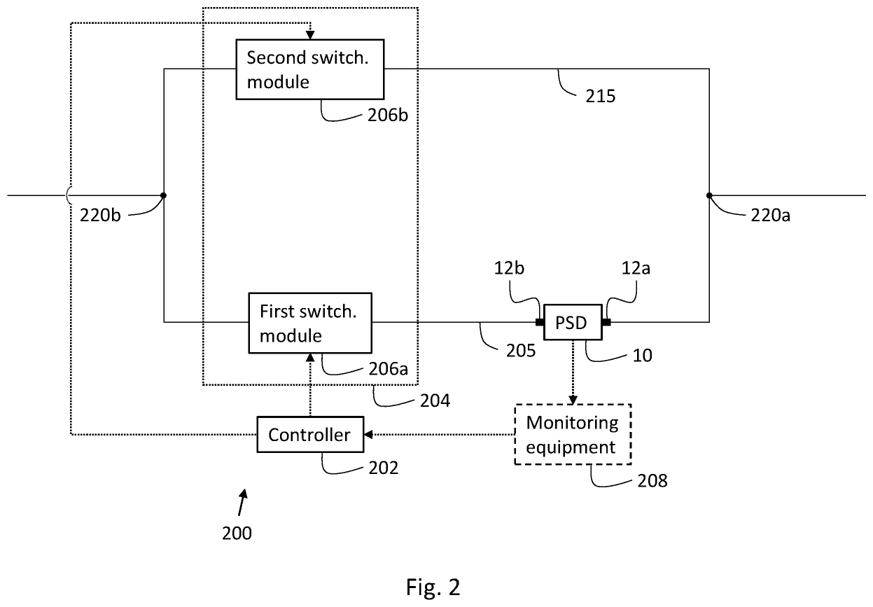

FIG. 2 is a combined block-circuit diagram of a switch system 200 for one or more rechargeable PSDs, according to some embodiments. Switch system 200 corresponds to specific embodiments of switch system 100, wherein the switch assembly includes a pair of switch modules. More specifically, switch system 200 includes a controller 202 and a switch assembly 204 including a pair of switching modules 206, which are functionally associated with controller 202. Switching modules 206 include a first switching module 206a and a second switching module 206b. Controller 202 and switch assembly 204 correspond to specific embodiments of controller 102 and switch assembly 104, respectively. According to some embodiments, switch system 200 may further include monitoring equipment 208, which is functionally associated with controller 202. Monitoring equipment 208 corresponds to specific embodiments of monitoring equipment 108.

Also shown in FIG. 2 is PSD 10. First switching module 206a is electrically-coupled to PSD 10 in series along a first line 205 (e.g. an electrical wire) extending between an electrical input 220a, which forms a first three-way junction, and an electrical output 220b, which a forms a second three-way junction. Electrical input 220a and electrical output 220b correspond to specific embodiments of electrical input 120a and electrical output 120b, respectively, of switch system 100. PSD 10 is positioned on first line 205 such that a positive polarity of PSD 10 points in the input-to-out direction (i.e. from electrical input 220a to electrical output 220b). Second switching module 206b is positioned along a second line 215 (e.g. an electrical wire) extending from electrical input 220a to electrical output 220b, and is thus electrically-coupled (electrically-connected) to PSD 10 (and first switching module 206a) in parallel. First line 205 defines a first conduction path, which corresponds to specific embodiments of first conduction path 105 of switch system 100. Second line 215 defines a second conduction path, which corresponds to specific embodiments of the at least one ACP of switch system 100.

According to some embodiments, first switching module 206a may be switched between two module states S₀ and S_{b}, and second switching module 206b may be switched between the module state S₀, the module state S_{b}, and a module state Sₚ. In the module state S_{b}, current may be conducted through the switching module, both from input to output and from output to input. Thus, when first switching module 206a is in the module state S_{b}, current can flow through first line 205 both from electrical input 220a to electrical output 220b and vice-versa (one direction at a time). Similarly, when second switching module 206b is in the module state S_{b}, current can flow through second line 215 from electrical input 220a to electrical output 220b and vice-versa (one direction at a time).

In the module state S₀, current cannot be conducted through the switching module. Thus, when first switching module 206a is in the module state S₀, current cannot flow through first line 205 from electrical input 220a input to electrical output 220b, nor from electrical output 220b to electrical input 220a. Similarly, when second switching module 206b is in the module state S₀, current cannot flow through second line 215, from electrical input 220a to electrical output 220b, nor from electrical output 220b to electrical input 220a.

When second switching module 206b is in the module state Sₚ, current flow therethrough, in the output-to-input direction is blocked. That is, in the module state Sₚ, current can only be conducted through second switching module 206b in the input-to-output direction.

When switching modules 206 are in the joint state (S_{b}, Sₚ), switch assembly 204 is in the first assembly state Q₁. When switching modules 206 are in the joint state (S₀, S_{b}), switch assembly 204 is in the second assembly state Q₂. When switching modules 206 are in the joint state (S_{b}, S₀), switch assembly 204 is in the third assembly state Q₃. The first entry in the brackets denotes the module state of first switching module 206a and the second entry in the brackets denotes the module state of second switching module 206b. That is, in the joint state (X, Y) first switching module 206a is in the state X (wherein X may be selected at least from S₀ and S_{b}) and second switching module 206b is in the state Y (wherein Y may be selected at least from S₀, Sₚ, and S_{b}), wherein it is understood that the state X=Y=S_{b} is inaccessible, so that possibility of discharge of PSD 10 onto itself is precluded. The inaccessibility may be imposed (realized) by software and/or hardware (e.g. using an interlock).

Table 1 summarizes the identification of the joint states of switching modules 206 with the assembly states of switch assembly 204 in the above-described embodiments of switch system 200, wherein second switching module 206b is switchable between each of the module states S_{b}, Sₚ, and S₀. The entries on the leftmost column of Table 1 correspond to the possible states of first switching module 206a and the entries on the top row correspond to the possible states of second switching module 206b.

TABLE 1

| | S_{b} | Sₚ | S₀ |
|---|---|---|---|
| S_{b} | inaccessible | Q₁ | Q₃ |
| S₀ | Q₂ | optional | Q₀ |

The module states S₀, S_{b}, and S_{b} should be understood in broad operative terms in the sense of being defined by the possible conduction directions but not in terms of a specific current-to-voltage characteristic (i.e. I-V curve). Thus, the fact that each of first switching module 206a and second switching module 206b is switchable between the module states S₀ and S_{b} (second switching module is additionally switchable to the module state Sₚ) does not imply that the switching modules I-V curves of the switching modules are identical nor that any identity of components included in the switching module.

According to some alternative embodiments, second switching module 206b may only be switched between the module state S_{b} and the module state Sₚ. When switching modules 206 are in the joint state (S₀, Sₚ), switch assembly 204 is in the alternative third assembly state Q₃′. (And when switching modules 206 are in the joint state (S_{b}, Sₚ) or the joint state (S₀, S_{b}), switch assembly 204 is in the first assembly state Q₁ or the second assembly state Q₂, respectively.) The joint state X=Y=S_{b} is inaccessible, so that possibility of discharge of PSD 10 onto itself is precluded. The inaccessibility may be imposed by software and/or hardware (e.g. using an interlock).

Table 2 summarizes the identification of the joint states of switching modules 206 with the assembly states of switch assembly 204 in the above-described embodiments of switch system 200, wherein second switching module 206b is switchable between the each of module states S_{b} and Sₚ (and is not switchable to the module state S₀). The entries on the leftmost column of Table 1 correspond to the possible states of first switching module 206a and the entries on the top row correspond to the possible states of the second switching module 206b.

TABLE 2

| | S_{b} | Sₚ |
|---|---|---|
| S_{b} | inaccessible | Q₁ |
| S₀ | Q₂ | Q₃′ |

The term “joint state” in reference to two module states of two switching modules, respectively, of a switch assembly, as used herein, is interchangeable with the term “assembly state” in reference to the switch assembly.

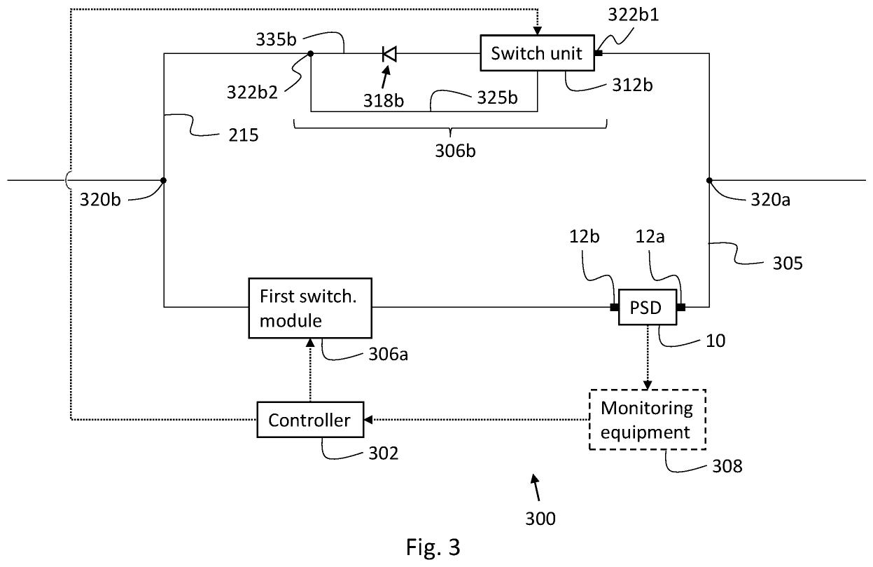

Referring to FIG. 3, FIG. 3 is a combined block-circuit diagram of a switch system 300 for one or more rechargeable PSDs, according to some embodiments. Switch system 300 corresponds to specific embodiments of switch system 200. More specifically, switch system 300 includes a first switching module 306a and a second switching module 306b, which correspond to specific embodiments of first switching module 306a and second switching module 306b, respectively. First switching module 306a is positioned on a first line 305 extending from an electrical input 320a to an electrical output 320b. Second switching module 306b is positioned on a second line 315 extending from electrical input 320a to electrical output 320b. Lines 305 and 315 correspond to specific embodiments of lines 205 and 215, respectively, of switch system 200. Electrical input 320a and electrical output 320b correspond to specific embodiments of electrical input 220a and electrical output 220b, respectively, of switch system 200. Further indicated are a controller 302 and monitoring equipment 308, which correspond to specific embodiments of controller 202 and monitoring equipment 208, respectively, of switch system 200.

Second switching module 306b includes a switching unit 312b, a diode 318b, a third line 325b (e.g. an electrical wire), and a fourth line 335b (e.g. an electrical wire). Also indicated are a second switching module input 322b1 and a second switching module output 322b2 of second switching module 306b. Each of Third line 325b and fourth line 335b extends from second switching module output 322b2 to switching unit 312b. Second switching module output 322b2, thus forms a three-way junction (as third line 325b and fourth line 335b converge via second switching module output 322b into second line 315). Second switching module input 322b1 is positioned between electrical input 320a and switching unit 312b, adjacently to switching unit 312b. Second switching module output 322b2 is positioned between switching unit 312b and electrical output 320b. Diode 318b is mounted on fourth line 335b.

According to some embodiments, switching unit 312b may be switchable between three states: a two-way conduction state M_{b}, a one-way conduction state Mₚ, and a no-conduction state M₀. In such embodiments, when switching unit 312b in the state M_{b}, Mₚ, or M₀, second switching module 306b is in the module states S_{b}, Sₚ, or S₀, respectively. More specifically, when switching unit 312b is in the state M_{b}, bidirectional current flow through third line 325b (and through switching unit 312b), is possible, and consequently, bidirectional current flow through second line 315 is possible. When switching unit 312b is in the state Mₚ, unidirectional current flow through fourth line 335b (and through switching unit 312b) in the input-to-output direction, is possible, while current flow through third line 325b is blocked. Consequently, unidirectional current flow through second line 315 from electrical input 320a to electrical output 320b is possible. When switching unit 312b is in the state M₀, current flow through each of third line 325b and fourth line 335b is blocked, and consequently, current flow through second line 315 is blocked.

According to some alternative embodiments, switching unit 312b is switchable between the two-way conduction state M_{b} and the one-way conduction state Mₚ, but cannot be switched to the no-conduction state M₀. In such embodiments, when switching unit 312b in the state M_{b} or the state Mₚ, second switching module is in the module state S_{b} or the module state Sₚ, respectively.

According to some alternative embodiments, not depicted in FIG. 3, the diode may be positioned between the switching unit and electrical input 320a. More specifically, the third line and fourth line may extend from the switching unit in the direction of electrical input 320a. The third line and fourth line may converge into a second line segment of second line 315, which extends from the convergence point to electrical input 320a. The diode may be mounted on the fourth line so as to prevent current flow through the fourth line from the convergence point to the switch unit.

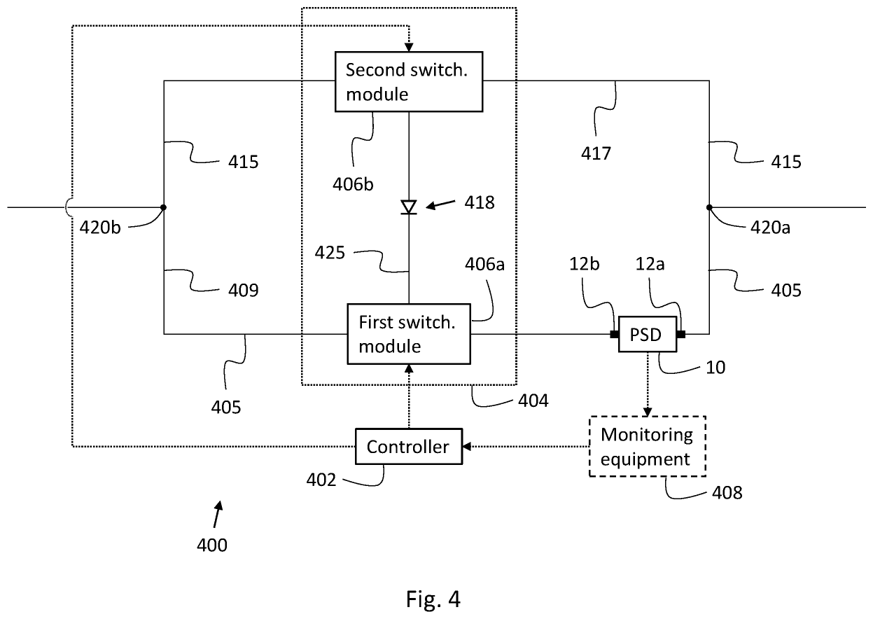

Referring to FIG. 4, FIG. 4 is a combined block-circuit diagram of a switch system 400 for one or more rechargeable PSDs, according to some embodiments. Switch system 400 corresponds to specific embodiments of switch system 100. More specifically, switch system 400 includes a switch assembly 404, which corresponds to specific embodiments of switch assembly 104. Switch assembly 404 includes a first switching module 406a and a second switching module 406b positioned on a first line 405 and a second line 415, respectively. First line 405 and second line 415 define a first conduction path and a second conduction path, which correspond to specific embodiments of first conduction path 105 and a first of the at least one ACP of switch system 100. Each of first line 405 and second line 415 extends from an electrical input 420a to an electrical output 420b. Electrical input 420a and electrical output 420b correspond to specific embodiments of electrical input 120a and electrical output 120b, respectively, of switch system 100. Further indicated are a controller 402 and monitoring equipment 408, which correspond to specific embodiments of controller 102 and monitoring equipment 108, respectively, of switch system 100.

Switch assembly 404 additionally includes a third line 425 (e.g. an electrical wire) and a diode 418. Third line extends 425 extends between first switching module 406a and second switching module 406b. Diode 418 is mounted on third line 425 such that current flow along third line 415 from first switching module 406a to second switching module 406b is blocked. Also indicated are a first line segment 409 and a second line segment 417. First line segment 409 extends along first line 405 from first switching module 406a to electrical output 420b. Second line segment 417 extends along second line 415 from electrical input 420a to second switching module 406b. Second line segment 417, third line 425, and first line segment 409 jointly define a third conduction path corresponding to specific embodiments of a second of the at least one ACP of switch system 100.

According to some embodiments, first switching module 406a may be switched between two module states S₀′ and S_{b}′, and second switching module 406b may be switched between three module states S₀″, S_{b}″, and Sₚ″. In the module state S_{b}′, current may be conducted through first switching module 406a in both directions. Thus, when first switching module 406a is in the module state S_{b}′, current can flow through first line 405 both from input to output and from vice-versa (one direction at a time). Similarly, in the module state S_{b}″, current may be conducted through second switching module 406b in both directions. Thus, when second switching module 406b is in the module state S_{b}″, current can flow through second line 415 from input to output and vice-versa (one direction at a time).

In the module state S₀′, current flow through first switching module 406a is blocked. Thus, when first switching module 406a is in the module state S₀′, current cannot flow between input and output solely along first line 405. Similarly, in the module state S₀″, current flow through second switching module 406b is blocked. Thus, when second switching module 406b is in the module state S₀″, current cannot flow between input and output solely along second line 415.

When second switching module 406b is in the module state Sₚ″, current flow therethrough, in the output-to-input, is blocked. That is, in the module state Sₚ″, current can only be conducted through second switching module 406b in the input-to-output direction. More specifically, when second switching module 406b is in the module state Sₚ″, current can be conducted along the third conduction path (i.e. the path defined by second line segment 417, third line 425, and first line segment 409) from electrical input 420a to electrical output 420b, but cannot be conducted along the full length of second line 415 (more precisely, along second line 415 current can only be conducted along second line segment 417).

When switching modules 406 are in the joint state (S_{b}′, Sₚ″), switch assembly 404 is in the first assembly state Q₁. When switching modules 406 are in the joint state (S₀′, S_{b}″), switch assembly 404 is in the second assembly state Q₂. When switching modules 406 are in the joint state (S_{b}′, S₀″), switch assembly 404 is in the third assembly state Q₃. It is to be understood that the joint state (S_{b}′, S_{b}″) is inaccessible, so that possibility of discharge of PSD 10 onto itself is precluded. The inaccessibility may be imposed by software and/or hardware (e.g. using an interlock).

According to some alternative embodiments, second switching module 406b may only be switched between the module state S_{b}″ and the module state Sₚ″. When switching modules 406 are in the joint state (S₀′, Sₚ″), switch assembly 404 is in the alternative third assembly state Q₃′. (And when switching modules 406 are in the joint state (S_{b}′, Sₚ″) or the joint state (S₀′, S_{b}″), switch assembly 404 is in the first assembly state Q₁ or the second assembly state Q₂, respectively.) The joint state (S_{b}′, S_{b}″) is inaccessible, so that possibility of discharge of PSD 10 onto itself is precluded. The inaccessibility may be imposed by software and/or hardware (e.g. using an interlock).

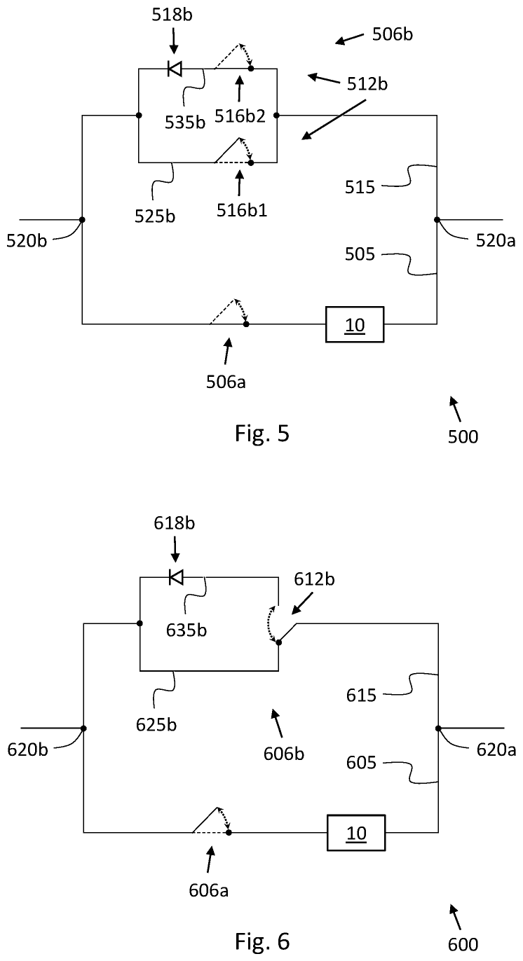

FIGS. 5-9 depict various specific embodiments of switch systems 300 and 400, according to some embodiments. Referring to FIG. 5, FIG. 5 is a circuit diagram of a switch system 500 including a first switching module 506a and a second switching module 506b, according to some embodiments. Switch system 500 corresponds to specific embodiments of switch system 300, and is shown in FIG. 5 in the module state (S_{b}, Sₚ). A controller and monitoring equipment of switch system 500 are not shown.

First switching module 506a and second switching module 506b corresponds to specific embodiments of first switching module 306a and second switching module 306b, respectively, of switch system 300. A switching unit 512b corresponds to specific embodiments of switching unit 312b of switch system 300. A first line 505, a second line 515, a third line 525b, and a fourth line 535b correspond to specific embodiments of first line 305, second line 315, third line 325b, and fourth line 335b, respectively, of switch system 300. An electrical input 520a and electrical output 520b correspond to specific embodiments of electrical input 320a and electrical output 320b, respectively, of switch system 300.

According to some embodiments, and as depicted in FIG. 5, first switching module 506a is a SPST switch.

Switching unit 512b may include a first switch 516b1 and a second switch 516b2. First switch 516b1 and second switch 516b2 are positioned on third line 525b and fourth line 535b, respectively, and are thus connected in parallel. Second switch 516b2 is connected in series to diode 518b. According to some embodiments, and as depicted in FIG. 5, each of first switch 516b1 and second switch 516b2 is or includes a SPST switch.

Further, it is to be understood that different combinations of states of switches 516b may correspond to a same module state. As a non-limiting example, the two composite states formed by first switch 516b1 and second switch 516b2, when first switching unit 516b is switched on, correspond to the same state of switching unit 512b, i.e. the two-way conduction state M_{b}. According to some embodiments, the two composite states of switching unit 512b may differ in their respective I-V curves (i.e. in their respective voltage regimes, wherein the current may flow in both directions).

More specifically, when first switch 516b1 is switched on (e.g. when the SPST switch is closed), current is capable of flowing bidirectionally along third line 525b and consequently along the full length of second line 515: Switching unit 512b is thus the state M_{b} (second switch 516b2 may be switched on or off) and second switching module 506b is in the module state S_{b}. When first switch 516b1 is switched off (e.g. when the SPST switch is open) and second switch 516b2 is switched on, current is capable of flowing unidirectionally in the input-to-output direction along fourth line 535b and current flow through third line 525b is blocked. Consequently, current is capable of unidirectional flow from input to output along second line 515: Switching unit 512b is thus the state Mₚ and second switching module 506b is in the module state Sₚ. When each of first switch 516b1 and second switch 516b2 is switched off, current flow through both of third line 525b and fourth line 535b is blocked, so that current flow through second line 515 is blocked: Switching unit 512b is thus the state M₀ and second switching module 506b is in the module state S₀.

Switch system 500 is thus switchable between the first assembly state Q₁, the second assembly state Q₂, and the third assembly state Q₃. In the first assembly state Q₁, first switch 516b1 is switched off, second switch 516b2 is switched on, and first switching module 506b is in the state S_{b}. In the second assembly state Q₂, first switch 516b1 is switched on (second switch 516b2 may be switched on or off), and first switching module 506b is in the state S₀. In the third assembly state Q₃, first switch 516b1 and second switch 516b2 are switched off, and first switching module 506b is in the state S_{b}.

FIG. 6 is a circuit diagram of a switch system 600 including a first switching module 606a and a second switching module 606b, according to some embodiments. Switch system 600 corresponds to specific embodiments of switch system 300, and is shown in FIG. 6 in the module state (S₀, S_{b}). Switch system 600 is similar to switch system 500 but differs therefrom in that the second switching module thereof includes a SPDT switch instead of a pair of SPST switches. A controller and monitoring equipment of switch system 600 are not shown.

First switching module 606a and second switching module 606b correspond to specific embodiments of first switching module 306a and second switching module 306b, respectively, of switch system 300. A switching unit 612b corresponds to specific embodiments of switching unit 312b of switch system 300. A first line 605, a second line 615, a third line 625b, and a fourth line 635b correspond to specific embodiments of first line 305, second line 315, third line 325b, and fourth line 335b, respectively, of switch system 300. An electrical input 620a and electrical output 620b correspond to specific embodiments of electrical input 320a and electrical output 320b, respectively, of switch system 300.

According to some embodiments, and as depicted in FIG. 6, first switching module 606a is a SPST switch.

A line segment 617 of second line 615 extends from electrical input 620a to switching unit 612b. Switching unit 612b is configured to controllably electrically connect line segment 617 to either third line 625b or fourth line 635b. According to some embodiments, and as depicted in FIG. 6, switching unit 612b is or includes a SPDT switch.

When switching unit 612b connects line segment 617 to third line 625b, current is capable of flowing along second line 615 from input to output and vice-versa: Switching unit 612b is thus the state M_{b} and second switching module 606b is in the module state S_{b}. When switching unit 612b connects line segment 617 to fourth line 635b, current is capable of flowing along second line 615 from input to output, but not vice-versa: Switching unit 612b is thus the state Mₚ and second switching module 606b is in the module state Sₚ.

Switch system 600 is thus switchable between the first assembly state Q₁, the second assembly state Q₂, and the alternative third assembly state Q₃′. In the first assembly state Q₁, first switching module 606a is in the state S_{b} and switching unit 612b connects line segment 617 to fourth line 635b. In the second assembly state Q₂, first switching module 606a is in the state S₀ and switching unit 612b connects line segment 617 to third line 625b. In the alternative third assembly state Q₃′, first switching module 606a is in the state S₀ and switching unit 612b connects line segment 617 to fourth line 635b.

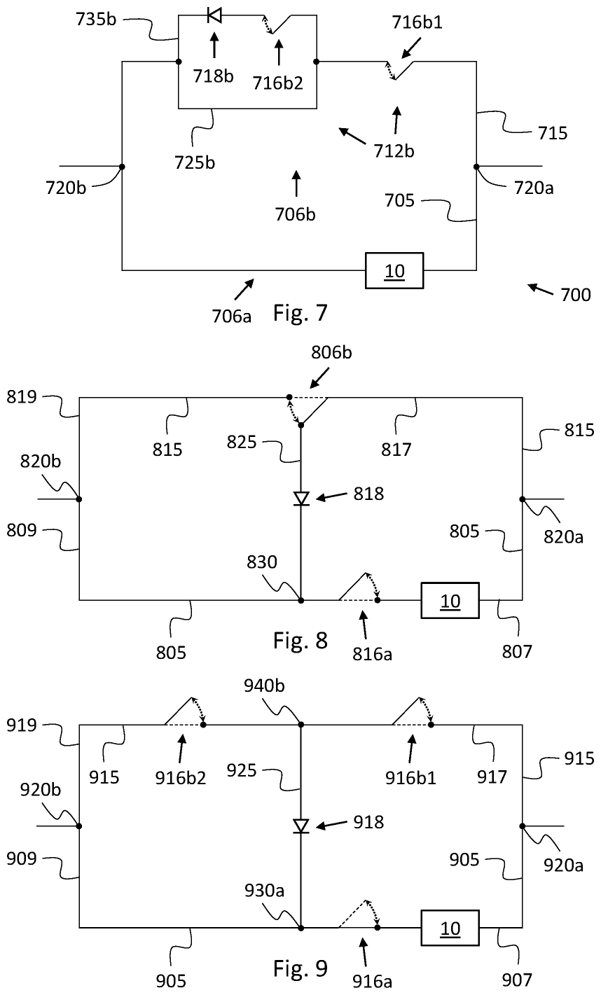

FIG. 7 is a circuit diagram of a switch system 700 including a first switching module 706a and a second switching module 706b, according to some embodiments. Switch system 700 corresponds to specific embodiments of switch system 300, and is shown in FIG. 7 in the module state (S_{b}, S₀). A controller and monitoring equipment of switch system 700 are not shown.

Switch system 700 is similar to switch system 500 but differs therefrom in the positioning of one of the switches of the switching unit, as described below. More specifically, first switching module 706a is similar to first switching module 506a of switch system 500. A first electrical line 705 and a second electrical line 715 are similar to first electrical line 505 and second electrical line 515, respectively, of switch system 500. An electrical input 720a and electrical output 720b are similar to electrical input 520a and electrical output 520b, respectively, of switch system 500.

Second switching module 706b includes a switch unit 712b, a diode 718b, a third line 725b, a fourth line 735b connected in parallel to third line 725b, a fifth line 745b, and a three-way junction 730b Switch unit 712b includes a first switch 716b1 and a second switch 716b2. Second switch 716b2 and diode 718b are mounted fourth line 725b similarly to the mounting of second switch 516b2 and diode 518b of switch system 500 on third line 525b. A line segment 717 of second line 715 extends from electrical input 720a to first switch 716b1. Fifth line 745b extends in the input-to-output direction from first switch 716b2, diverging at junction 730b into third line 725b and fourth line 735b.

FIG. 8 is a circuit diagram of a switch system 800 including a first switching module 806a and a second switching module 806b, according to some embodiments. Switch system 800 corresponds to specific embodiments of switch system 400, and is shown in FIG. 8 in the module state (S₀′, Sₚ″). A controller and monitoring equipment of switch system 800 are not shown.

First switching module 806a and second switching module 806b correspond to specific embodiments of first switching module 406a and second switching module 406b, respectively, of switch system 400. A first line 805, a second line 815, and a third line 825 correspond to specific embodiments of first line 405, second electrical line 415, and third line 425, respectively, of switch system 400. An electrical input 820a and an electrical output 820b correspond to specific embodiments of electrical input 420a and electrical output 420b, respectively, of switch system 400. A diode 818 is mounted on third line 825 and corresponds to specific embodiments of diode 418 of switch system 400.

First switching module 806a may include a switch 816a and a junction 830a. According to some embodiments, and as depicted in FIG. 8, a first line segment 807 of first line 805 extends from electrical input 820a to switch 816a. A second line segment 809 of first line 805 extends from junction 830a to electrical output 820b. Switch unit 816a is positioned on first line 805 between electrical input 820a and junction 830a. According to some embodiments, switch 816a is a SPST switch.

Third line 825 is connected on one end thereof to junction 830a and is controllably connectable on a second end thereof to second line 815.

A third line segment 817 of second line 815 extends from electrical input 820a to second switching module 806b. A fourth line segment 819 of second line extends from second switching module 806b to electrical output 820b. Second switching module 806b is configured to controllably electrically connect third line segment 817 to either fourth line segment 819 or third line 825. According to some embodiments, and as depicted in FIG. 8, second switching module 806b is or includes a SPDT switch.

When second switching module 806b connects third line segment 817 to fourth line segment 819, current is capable of flowing along second line 815 from input to output and vice-versa: Second switching module 806b is thus the module state S_{b}″. When second switching module 806b connects third line segment 817 to third line 825, current is capable of flowing along from electrical input 820a to electrical output 820b via third line segment 817, third line 825, and second line segment 819, but not vice-versa: Second switching module 806b is thus the module state Sₚ″.

Switch system 800 is thus switchable between the first assembly state Q₁, the second assembly state Q₂, and the alternative third assembly state Q₃′. In the first assembly state Q₁, switch 816a is switched on (i.e. closed) and second switching module 806b connects third line segment 817 to third line 825. In the second assembly state Q₂, switch 816a is switch off (i.e. open) and second switching module 806b connects third line segment 817 to fourth line segment 819. In the alternative third assembly state Q₃′, switch 816a is switch off and second switching module 612b connects third line segment 817 to third line 825.

According to some alternative embodiments, not depicted in FIG. 8, the switch of first switching module 806a may be positioned between electrical output 820b and junction 830.

FIG. 9 is a circuit diagram of a switch system 900 including a first switching module 906a and a second switching module 906b, according to some embodiments. Switch system 900 corresponds to specific embodiments of switch system 400, and is shown in FIG. 9 in the module state (S_{b}′, S₀″). Switch system 900 is similar to switch system 800 but differs therefrom in that the second switching module thereof includes a pair of SPST switches instead of a SPDT switch. A controller and monitoring equipment of switch system 900 are not shown.

First switching module 906a and second switching module 906b correspond to specific embodiments of first switching module 406a and second switching module 406b, respectively, of switch system 400. A first line 905, a second line 915, and a third line 925 correspond to specific embodiments of first line 405, second electrical line 415, and third line 425, respectively, of switch system 400. An electrical input 920a and an electrical output 920b correspond to specific embodiments of electrical input 420a and electrical output 420b, respectively, of switch system 400. A diode 918 is mounted on third line 925 and corresponds to specific embodiments of diode 418 of switch system 400.

First switching module 906a may include a first switch 916a and a first junction 930a, which are similar to switch 816a and junction 830a of first switching module 806a, respectively, of switch system 800. Switch 916a is mounted on first line 905 between electrical input 920a and junction 930a. According to some embodiments, switch 816a is a SPST switch.

Second switching module 906b may include a second switch 916b1, a third switch 916b2, and a second junction 940b. Second switch 916b1 is positioned on second line 915 between electrical input 920a and second junction 940b. Third switch 916b2 is positioned on second line 915 second junction 940b and between electrical output 920a. Third line 925 extends from first junction 930a to second junction 940b. According to some embodiments, and as depicted in FIG. 9, each of second switch 916b1 and third switch 916b2 is a SPST switch.

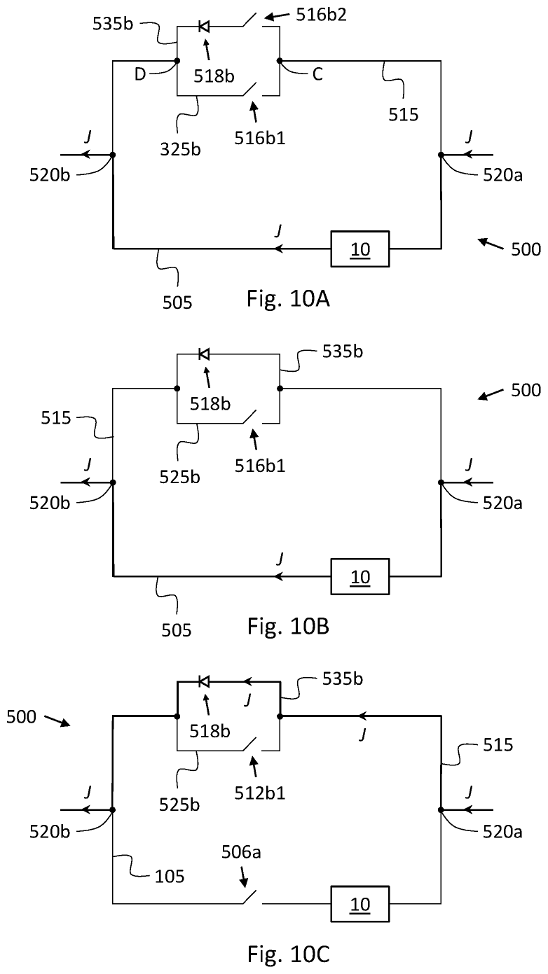

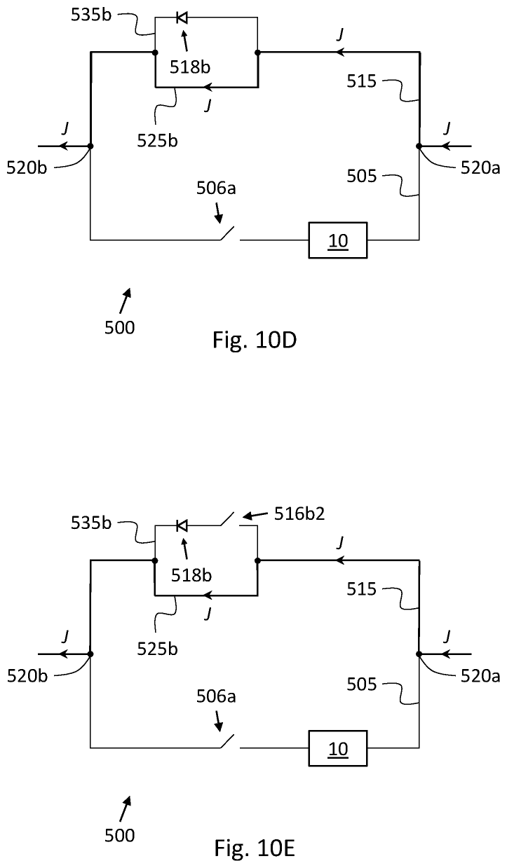

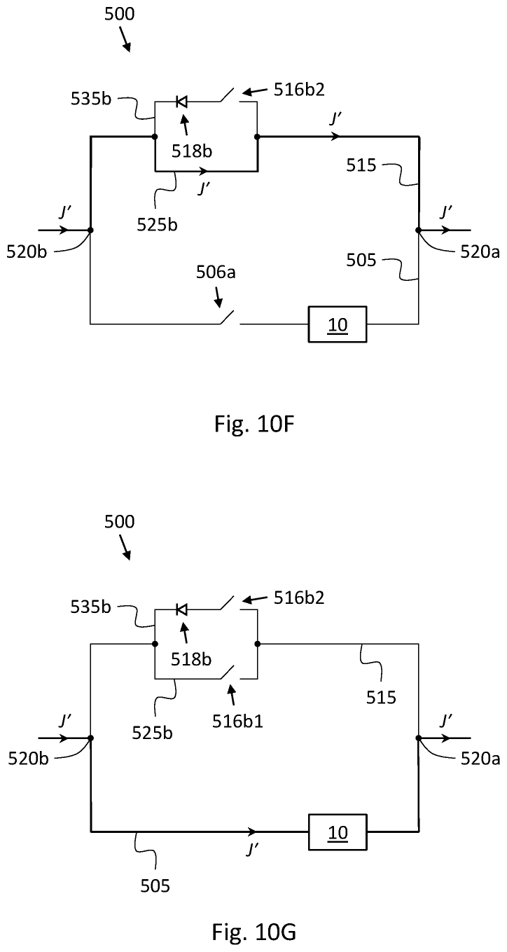

FIGS. 10A-10E depict successive circuit states of switch system 500, during the bypassing of PSD 10, starting at an initial state wherein PSD 10 is discharging, according to some example embodiments. In FIG. 10A, switching modules 506 are in the joint state (S_{b}, S₀) with a current J flowing exclusively through first line 505 in the input-to-output direction. First switch 516b1 and second switch 516b2 are each switch off (i.e. open).

In FIG. 10B, second switch 516b1 has been switched on (so that second switching module 506b is in the module state Sₚ). Current is now in principle capable of flowing through second line 515 from electrical input 520a to electrical output 520b. However, due to the resistance of diode 518b virtually all of the current may continue being conducted through first line 505.

In FIG. 10C, first switching module 506a has been switched to the S₀ state (so that current flow therethrough is blocked). The current J now flows exclusively through second line 515 (and fourth line 535b) from electrical input 520a to electrical output 520b.

In FIG. 10D, first switching unit 516b1 has been switched on (so that second switching module 506b is in the module state S_{b}). The current J flows exclusively through second line 515 in the input-to-output direction. According to some embodiments, and as depicted in FIG. 10D, due to the resistance of diode 518b virtually all of the current J bypasses fourth 535b and flows through third line 525b.

In FIG. 10E, second switch 516b2 has been switched off. The current J flows exclusively through second line 515 in the input-to-output direction, and, specifically, exclusively through first third line 525b.

To enable PSD 10 so as to reach a circuit state, wherein PSD 10 is discharging, from an initial circuit state, wherein current flows in the input-to-output direction through second line 515, the sequence of switching operations, described above with respect to FIGS. 10A-10E, may be inverted.

FIGS. 10F and 10G depict two circuit states—the second state (depicted in FIG. 10G) being subsequent to the first state (depicted in FIG. 10F)—in the enabling of PSD 10 to a circuit state wherein PSD 10 is charging, starting from an initial circuit state, wherein current flows in electrical output 520b to electrical input 520a through second line 515, according to some example embodiments. In FIG. 10F, switching modules 506 are in the joint state (S₀, S_{b}) with a current J′ flowing exclusively through second line 515 (and through third line 525b) in the output-to-input direction. First switch 516b1 is switch on and second switch 516b2 is switched off.

In FIG. 10G, switching modules 506 are in the joint state (S_{b}, S₀) with the current J′ flowing exclusively through first line 505 from electrical output 520b to electrical input 520a, so that PSD 10 is being charged. First switching module 506a has been switched to the module state S_{b} and first switch 516b1 has been switched off (second switch 516b2 remains switched off).

According to some embodiments, the switching of first switch 516b1 and first switching module 506a may be effected substantially simultaneously (so that a short-circuit state is not realized at any point during the transition).

Alternatively, according to some other embodiments, the switching from (S₀, S_{b}) to (S_{b}, S₀) is indirect, with the switching involving passage through an intermediate state, wherein current flow between electrical output 520b and electrical input 520a is blocked (i.e. current does not flow through any of first line 505 and second line 515). According to some embodiments, the current flow may be blocked by switching off first switch 516b1 prior to switching first switching module 506a to the module state S_{b} (so that in the intermediate state the pair of switching modules 506 is in the joint state (S₀, S₀)).

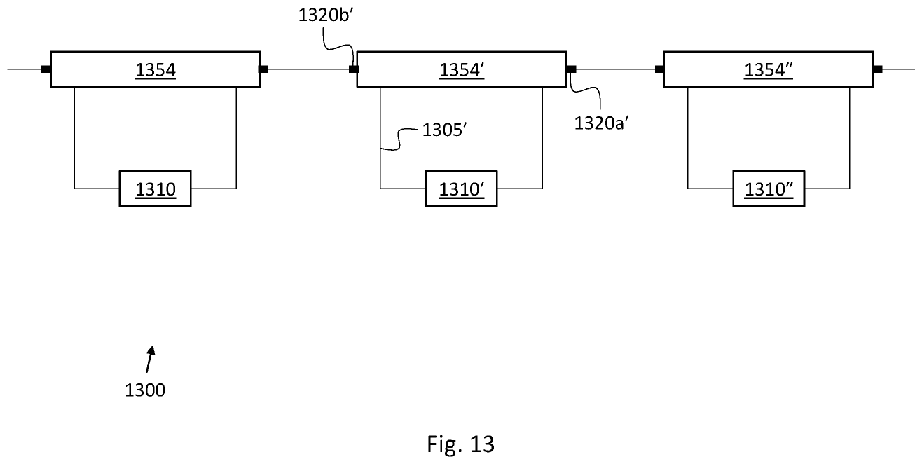

Alternatively, according to some embodiments, specifically, embodiments, wherein PSD 10 is included in a plurality of PSDs, which, when enabled, are connected in series (essentially, as depicted in FIG. 13, for example), a main switch may be employed to block current flow through first line 505 and second line 515, by blocking current flow to the whole plurality of PSDs.

To bypass PSD 10 so as to reach a circuit state, wherein current flows from electrical output 520b to electrical input 520a through second line 515, from an initial circuit state wherein PSD 10 is charging, the sequence of switching operations described above with respect to FIGS. 10F and 10G may be inverted.

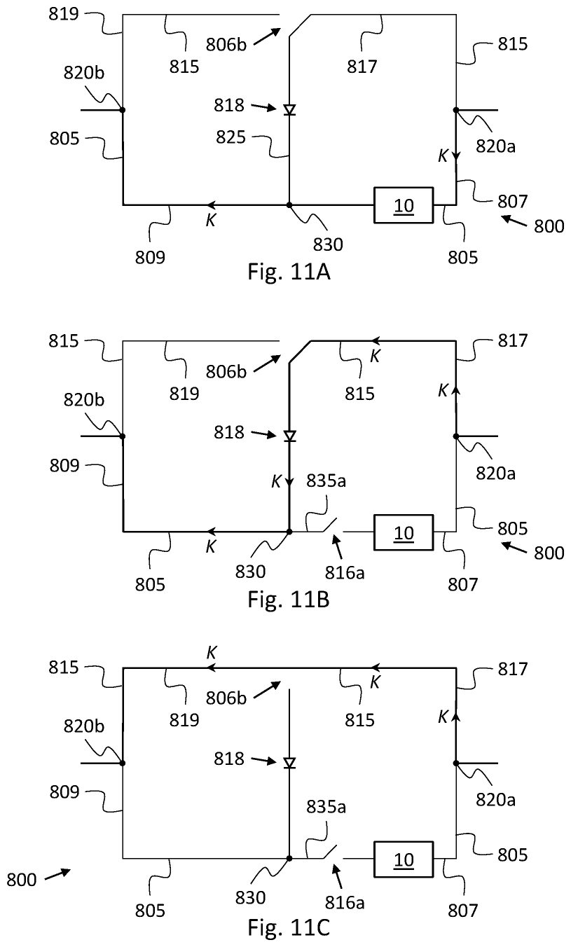

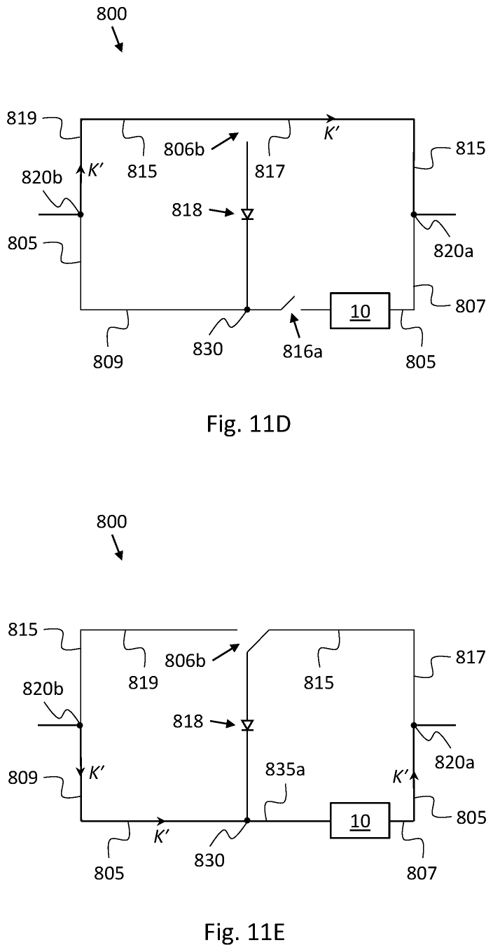

FIGS. 11A-11E depict successive circuit states of switch system 800, during the bypassing of PSD 10, starting at an initial state wherein PSD 10 is discharging, according to some example embodiments. In FIG. 11A, switching modules 606 are in the joint state (S_{b}′, Sₚ″) with a current K flowing virtually only through first line 805 from electrical input 820a to electrical output 820b: Switch 816a is switched on (i.e. closed) and second switching unit 806b connects third line segment 817 to third line 825.

In FIG. 11B, switch 816a has been switched off (so that first switching module 806b is in the module state S₀′). The current K now flows from electrical input 820a to electrical output 820b exclusively through the third conduction path (i.e. through third line segment 817, third line 825, and second line segment 809).

In FIG. 11C, second switching module 806b has been switched to connect third line segment 817 to fourth line segment 819 (so that second switching module 806b is now in the module state S_{b}″). The current K now flows exclusively through second line 815 in the input-to-output direction.

To enable PSD 10 so as to reach a circuit state, wherein PSD 10 is discharging, from an initial circuit state, wherein current flows in the input-to-output direction through second line 815, the sequence of switching operations, described above with respect to FIGS. 11A-11C, may be inverted.

FIGS. 11D and 11E depict two circuit states—the second state (depicted in FIG. 11D) being subsequent to the first state (depicted in FIG. 11E)—in the enabling of PSD 10 to a circuit state wherein PSD 10 is charging, starting from an initial circuit state, wherein current flows from electrical output 820b to electrical input 820a through second line 815, according to some example embodiments. In FIG. 11D, switching modules 806 are in the joint state (S₀′, S_{b}″) with a current K′ flowing exclusively through second line 815 in the output-to-input direction: Switch 816a is switched off and second switching module 806b connects third line segment 817 to fourth line segment 819.

In FIG. 11E, switching modules 806 are in the joint state (S_{b}′, Sₚ″) with the current K′ flowing exclusively through first line 805 in the output-to-input direction, so that PSD 10 is being charged. Switch 816a is switched on and second switching module 806b connects third line segment 817 to third line 825.

According to some embodiments, the switching of switch 816a and second switching module 806b may be effected substantially simultaneously (so that a short-circuit state is not realized at any point during the transition).

Alternatively, according to some embodiments, the switching from (S₀′, S_{b}″) to (S_{b}′, Sₚ″) is indirect, with the switching involving passage through an intermediate state, wherein the current is switched off (i.e. current does not flow through any part of first line 805 and second line 815).

According to some embodiments, the current may be switched off by switching second switching module 806b to the module state Sₚ″ prior to switching on switch 816a (so that in the intermediate state switching modules 806 is in the state (S₀′, Sₚ″)). Alternatively, according to some embodiments, specifically, embodiments, wherein PSD 10 is included in a plurality of PSDs, which, when enabled, are connected in series (essentially, as depicted in FIG. 13, for example), a main switch may be employed to block current flow through first line 805 and second line 815, by blocking current flow to the whole plurality of PSDs.

To bypass PSD 10 so as to reach a circuit state, wherein current flows from electrical output 820b to electrical input 820a through second line 815, from an initial circuit state wherein PSD 10 is charging, the sequence of switching operations described above with respect to FIGS. 11D and 11E may be inverted.

It is noted that in FIGS. 10A-11E, “closed” (i.e. switched-on) SPST switches are not numbered. Thus, for example, in FIG. 10A first switching module 506a is not numbered, in FIG. 10B second switch 516b2 is not numbered, and in FIG. 10D first switch unit 516b2 is not numbered. Similarly, for example, in FIGS. 11A and 11E switch 816a is not numbered.

### Power Management Systems

FIG. 12 schematically depicts an energy storage 1200 including a PSD array 1260 and a power management system 1250 (PMS), according to some embodiments. PMS 1250 is configured to control and regulate charging and discharging of rechargeable PSDs 1210 in PSD array 1260. PSDs 1210 may differ from one another in output voltages, output currents, and/or capacities. In particular, PSDs 1210 may differ from one another in chemistry and/or conditions, i.e. state-of-health (SoH).

As used herein, the term “PSD array” is used to refer to an array of PSDs, that is, a plurality of PSDs. More specifically, according to some embodiments, the term “PSD array” may be used to refer to a plurality of PSDs that includes groups of interconnected or interconnectable PSDs. Thus, as non-limiting examples, a group (of interconnected or interconnectable) PSDs may include a plurality of serially connected or connectable PSDs and/or a plurality of PSDs connected or connectable in parallel. In addition, according to some embodiments, groups of PSDs may be connected or connectable to one another, e.g. in parallel and/or in series. Most generally, the term “PSD array” may be used to refer to an array of PSDs whose interconnections may be controllably modified, such as to allow rewiring the array.

According to some embodiments, PSD array 1260 may include repurposed battery modules or battery packs. That is, used battery modules or battery packs, which are no longer suitable for their original “roles”. According to some such embodiments, PSD array 1260 may include second-life EV battery packs. That is, used EV battery packs, which are no longer employable as EV battery packs (e.g. due to reduced capacity and/or reduced charging rates).

As used herein, the term “electric vehicle” is to be understood in an expansive manner and may refer to any electrically-powered vehicle, whether manned or autonomous, that includes one or more rechargeable battery modules or rechargeable battery packs. The term “electric vehicle” should also be understood to cover any hybrid vehicle whose battery may be charged by plugging it into an external power source (using an external or on-board charger). In particular, the term “electric vehicle” should be understood to cover electric scooters, bikes, motorcycles, passenger cars, vans, buses, trucks, aircrafts (such as drones, as well as manned planes and choppers), boats, ships, marine vessels (such as tankers, freighters, and barges), and (electric) mobile industrial machinery (such as tractors and forklifts).

PMS 1250 includes a controller 1202, a switch assembly 1256, and monitoring equipment 1208. Also indicated is a power conversion system (PCS) 1280, which, according to some embodiments, is included in PMS 1250. Switch assembly 1256 includes a plurality of switch assemblies 1204 (not all of which are numbered). Each switch assembly 1204 constitutes an embodiment of switch assembly 104. According to some embodiments, and as depicted in FIG. 12, each of switch assemblies 1204 is functionally associated with a respective PSD from PSD array 1260. Thus, for example a first switch assembly 1204′ is functionally associated with a first PSD 1210′, a second switch assembly 1204″ is functionally associated with a second PSD 1210″, and so on.

Controller 1202 may be configured to enable and disable (by circumventing) each of PSDs 1210 by switching the respective switch assembly between the assembly states Q₁, Q₂, and Q₃ or Q₃′, as taught above in the Switching systems subsection and as taught below in the Switching methods subsection. More specifically, by selectively disabling and enabling PSDs in PSD array 1260, PSD array 1260 may be reconfigured to address changes in the status of individual PSDs in PSD array 1260 and/or in the status of one or more rechargeable loads charged by PSD array 1260.

Monitoring equipment 1208 is configured to monitor SoCs and/or remaining capacities of PSDs 1210 and to send the monitored values thereof to controller 1202. Controller 1202 is configured to controllably switch each of the switch assemblies between the respective assembly states thereof based at least on the monitored SoC value and/or remaining capacity value of the respective PSD.

Controller 1202 may be configured to control operation of PCS 1280 and selectively functionally associate one or more of PSDs 1210 with PCS 1280, so as to allow charging rechargeable loads of different voltages, and adjusting, if necessary, the voltage supplied to a rechargeable load as the SoC thereof is increased. According to some embodiments, PCS 1280 may include one or more bidirectional inverters and/or one or more DC-DC converters or chargers (not shown).

More specifically, according to some embodiments, PCS 1280 may be configured to modify the value of the voltage supplied by some or all of PSDs 1210 when supplying power to an external load, such that the voltage output by (the some or all of) PSDs 1210 is equal to the operating voltage, or falls within a range of operating voltages, of the external load. In particular, PCS 1280 may be configured to allow charging rechargeable loads of different operating voltages, and adjusting, if necessary, the voltage supplied to a rechargeable load as the SoC thereof is increased. According to some embodiments, PCS 1280 may have bidirectional DC-DC conversion capabilities, so as to allow discharging a rechargeable load onto one or more of PSDs 1210. According to some embodiments, PCS 1280 may have AC-DC inversion capabilities, so as to allow charging one or more of PSDs 1280 using an AC power source, and/or to allow powering an external AC load.

PMS 1250 may include additional switches (not shown) configured to allow selectively connecting PSDs in PSD array 1260 to the DC-DC chargers in PCS 1280.

According to some embodiments, energy storage 1200 may be connectable to a power source (not shown). According to some embodiments, the power source may provide alternating current (AC)—for example, when the power source is a power grid—in which case the power source may be connected to energy storage 1200 via an AC-DC converter (which, according to some embodiments, may be included in PCS 1280). According to some embodiments, the power source may provide a direct current (DC)—for example, when the power source is a renewable energy plant. In such embodiments, the power source may be directly connected to energy storage 1200 (i.e. without an intermediate AC-DC converter). PMS 1250 may be configured to allow selectively charging each of PSDs 1210 from the power source. According to some embodiments, controller 1202 may be configured to allow charging one or more PSDs in PSD array 1260 while simultaneously discharging one or more other PSDs in PSD array 1260.

According to some embodiments, based on charge requirements of one or more rechargeable loads, controller 1202 is configured to decide, which of PSDs 1210 is or are to be employed to charge the one or more rechargeable loads, such that one or more of a power consumption, charging time, and electricity cost is minimized, or substantially minimized, and/or a desired trade-off there between is achieved. The charge requirements may include charging voltages, charging currents, and/or charging powers of the loads. The charge requirements may further include amounts of charge requested by each of the loads.

According to some embodiments, PCS 1280 may further include a DC-AC charger(s) (not shown) functionally associated with controller 1202, and configured to allow powering an AC load, and, in particular, charging a battery pack, which has its AC-DC charger built-in (such that it may only be connected to an AC current source).

According to some embodiments, energy storage 1200 may be an EV charging station, e.g. a commercial EV charging station for servicing electric cars. According to some embodiments, energy storage 1200 may be deployed at an airfield or a port in order to service electric aircrafts or electric watercrafts, respectively. According to some embodiments, energy storage 1200 may be deployed at a construction site, a mining site, or even a farm, wherein EVs and/or electric mobile industrial machinery (e.g. a tractor, a forklift, a dumper) are used. According to some embodiments, energy storage 1200 may be deployed at a parking lot, for example, an underground parking of an office building and/or a residential building.

### Switching Methods

According to an aspect of some embodiments, there is provided a method for bypassing a switched-equipped PSD in a plurality of PSDs, such as a plurality of switch-equipped PSDs 1300 of FIG. 13. Further provided is a complementary method for enabling to discharge a switched-equipped PSD in a plurality of PSDs. To facilitate the description, three switch-equipped PSDs are depicted: a first PSD 1310, a second PSD 1310′, and a third PSD 1310″. When enabled (i.e. non-bypassed), PSDs 1310, 1310′, and 1310″ are connected in series. Each switch system includes a first conduction path extending from an electrical input thereof to an electrical output thereof and passing through the respective PSD (e.g. a first conduction path 1305′ extends between an electrical input 1320a′ and an electrical output 1320b′ and passes through PSD 1310′). Each switch system further includes at least one ACP (not shown in FIG. 13) extending from the electrical input thereof to the electrical output thereof and which bypasses the respective PSD. Each PSD is said to be “switch-equipped” in the sense of being functionally associated with a respective switch system, such as switch system 100, as depicted in FIG. 1. PSDs 1310, 1310′, and 1310″ are functionally associated with switch assemblies 1354, 1354′, and 1354″, respectively. Each of switch assemblies 1354, 1354′, and 1354″ is a specific embodiment of switch assembly 104. Each of switch assemblies 1354, 1354′, and 1354″ is mounted on the respective PSD similarly to the mounting of switch assembly 104 on PSD 10. Thus, for example, switch assembly 1354′ is mounted on PSD 1310′ in an essentially similar manner to the mounting of switch assembly 104 on PSD 10.

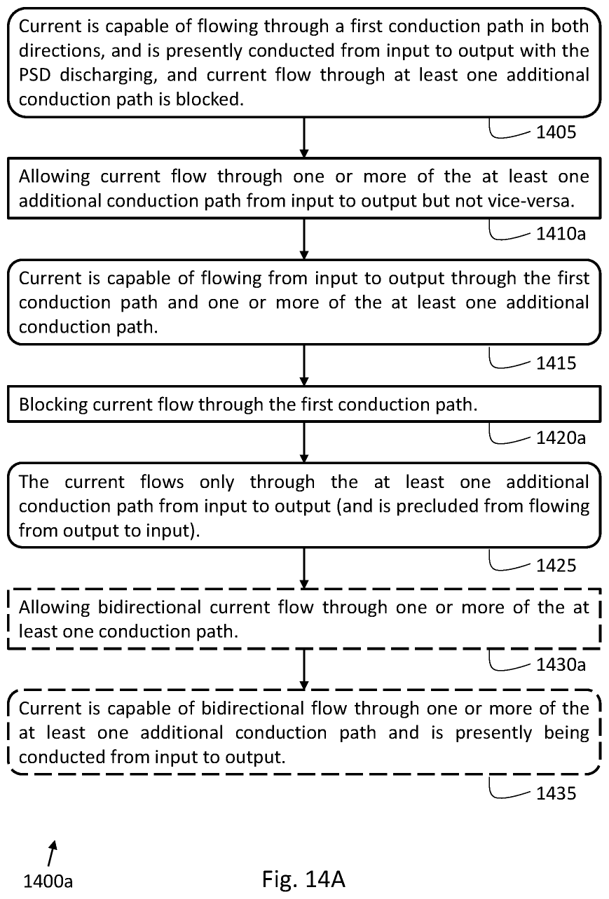

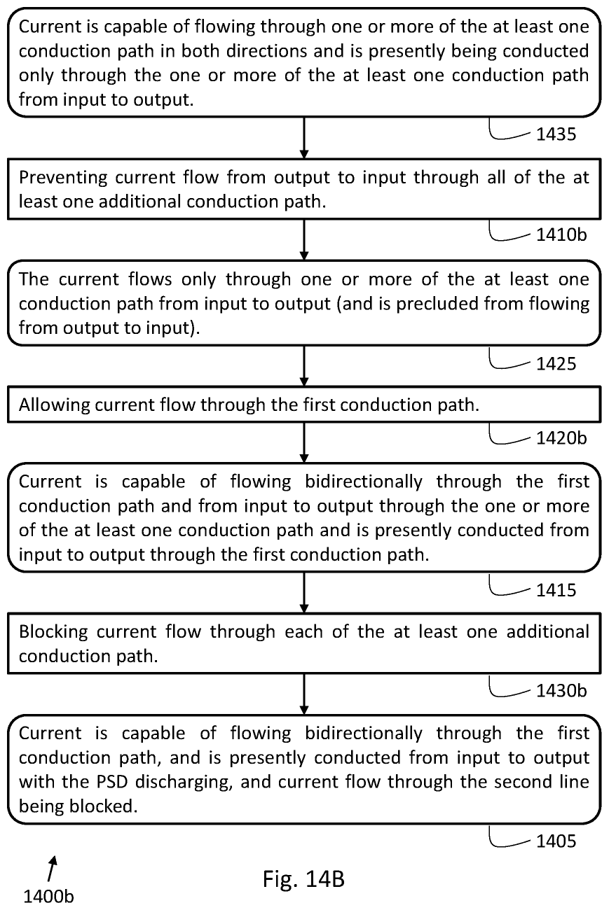

FIG. 14A presents a flowchart of a method 1400a for bypassing a switch-equipped PSD, according to some embodiments. Method 1400a allows bypassing (i.e. circumventing) one or more switch-equipped PSDs in a plurality of PSDs, which, when enabled, are serially-connected.

More specifically, in order to bypass a PSD (e.g. PSD 1310′), starting from a circuit state 1405 wherein one or more PSDs in the plurality of PSDs (e.g. plurality of PSDs 1300) are discharging and current is capable of being conducted through the first conduction path (e.g. first line 1305′) in both directions and is presently conducted from the respective electrical input (e.g. electrical input 1320a) to the respective electrical output (e.g. electrical output 1320b), and current flow through each of the at least one ACP is blocked, method 1400a may include:
An operation 1410a, wherein current flow through one or more of the at least one ACP from the electrical input to the electrical output but not vice-versa is allowed.
An operation 1420a, wherein the current is fully diverted to the one or more of the at least one ACP by blocking current flow through the first conduction path, thereby transforming to a circuit state 1325, wherein the current flows (only) through the one or more of the at least one conduction path from the electrical input to the electrical output.

According to some embodiments, the method further includes, following operation 1420a, an optional operation 1430a, wherein possibility of bidirectional current flow through one or more of the at least one conduction path is allowed, thereby transforming to a circuit state 1435. According to some embodiments, in operation 1430a, by allowing for the option of bidirectional current flow through the one or more of the at least one conduction path, the resistance may be lowered, so that power loss is reduced.

According to some embodiments, operations 1420a and 1430a may be performed substantially simultaneously.

FIG. 14B presents a flowcharts of a method 1400b for enabling a switch-equipped PSD to discharge, according to some embodiments. Method 1400b allows enabling to discharge one or more switch-equipped PSDs in a plurality of PSDs, which, when enabled, are serially-connected to discharge, starting from a circuit state wherein the one or more PSDs are bypassed.

More specifically, in order to enable the PSD to discharge, starting from a circuit state wherein one or more of the PSDs in the plurality of PSDs are discharging and current is capable of being conducted through one or more of the at last one ACP in both directions and is presently being conducted from the respective electrical input to the respective electrical output, and current flow through the first conduction path is blocked (that is, starting from the circuit state 1435), method 1400b may include:
An operation 1410b, wherein possibility of current flow through the one or more of the at least one conduction path from the electrical output to the electrical input is precluded, thereby transforming to circuit state 1425.
An operation 1420b, wherein the current is diverted to the first conduction path from the one or more of the at least one ACP by allowing current flow through the conduction path, thereby transforming to circuit state 1415.

According to some embodiments, the method further includes, following operation 1420b, an optional operation 1430b, wherein current flow through any of the at least one conduction path is blocked, thereby transforming to a circuit state 1405.

According to some embodiments, operations 1410b and 1420b may be performed substantially simultaneously.

It is to be understood that methods 1400a and 1400b may be implemented using switch system 100, and, in particular, any one of the specific embodiments thereof (described above).

As used herein, the nouns “energy” and “power” may be used interchangeably. Thus, for example, the terms “energy storage” and “power storage” are interchangeable. In particular, the terms “energy storage device” and “power storage device” are interchangeable. Similarly, the terms “energy source” and “power source” are interchangeable.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A switch system for one or more rechargeable power storage devices (PSDs), the switch system comprising a controller and a switch assembly, functionally associated with the controller;
wherein the switch system further comprises an electrical input (EI), an electrical output (EO), a first conduction path (FCP), and at least one additional conduction path (ACP) between the EI and the EO, such that the FCP passes via the PSD, with a positive polarity of the PSD pointing from the EI to the EO, and each of the at least one ACP circumventing the PSD; and
wherein the switch assembly is switchable by the controller at least between:
a first assembly state Q₁, wherein current is capable of flowing from the EI to the EO simultaneously via the FCP and one or more of the at least one ACP but is incapable of flowing from the EO to the EI via any of the at least one ACP;
a second assembly state Q₂, wherein current is capable of flowing between the EI and the EO via one or more of the at least one ACP but current flow via the FCP is blocked; and
(i) a third assembly state Q₃, wherein current is capable of flowing between the EI and the EO via the FCP but current flow via each of the at least one ACP is blocked, or (ii) an alternative third assembly state Q₃′, wherein current is capable of flowing from the EI to the EO via one or more of the at least one ACP but is incapable of flowing from the EO to the EI via any one thereof, and current flow via the FCP is blocked.

2. The switch system of claim 1, wherein the switch assembly is further switchable by the controller to a fourth assembly state Q₀, wherein current flow between the EI and the EO is blocked.

3. The switch system of claim 1, wherein the switch assembly comprises a first switching module and a second switching module;
wherein the first switching module is serially-connected to the PSD and is positioned together therewith on a first line extending from the EI to the EO, which corresponds to the FCP, and the second switching module is connected in parallel to the PSD and the first switching module and is positioned on a second line extending from the EI to the EO, which corresponds to the at least one ACP;
wherein each of the switching modules is switchable by the controller between a module state S_{b}, in which current is capable of bidirectional flow therethrough, and a module state S₀, in which current flow therethrough is blocked, and wherein the second switching module is additionally switchable by the controller to a module state Sₚ, in which current is only capable of flowing therethrough in the EI-to-the EO direction; and
wherein (i) when the first switching module is in module the S_{b} and the second switching module is in the module state Sₚ, the switch assembly is in the first assembly state Q₁, (ii) when the first switching module is in the S₀ and the second switching module is in the module state S_{b}, the switch assembly is in the second assembly state Q₂, (iii) when the first switching module is in the module state S_{b} and the second switching module is in the module state S₀, the switch assembly is in the third assembly state Q₃.

4. The switch system of claim 1, wherein the switch assembly comprises a first switching module and a second switching module;
wherein the first switching module is serially-connected to the PSD and is positioned together therewith on a first line extending from the EI to the EO, which corresponds to the FCP, and the second switching module is connected in parallel to the PSD and the first switching module and is positioned on a second line extending from the EI to the EO, which corresponds to the at least one ACP;
wherein each of the switching modules is switchable by the controller to a module state S_{b}, in which current is capable of bidirectional flowing therethrough, wherein the first switching module is additionally switchable by the controller to a module state S₀, in which current flow therethrough is blocked, and wherein the second switching module is additionally switchable by the controller to a module state Sₚ, in which current is only capable of flowing therethrough in the EI-to-EO direction; and
wherein (i) when the first switching module is in the module state S_{b} and the second switching module is in the module state Sₚ, the switch assembly is in the first assembly state Q₁, (ii) when the first switching module is in the module state S₀ and the second switching module is in the module state S_{b}, the switch assembly is in the second assembly state Q₂, and (iii) when the first switching module is in the module state S₀ and the second switching module is in the module state Sₚ, the switch assembly is in the alternative third assembly state Q₃′.

5. The switch system claim 3, wherein the controller is further configured to:
circumvent the PSD, starting from an initial circuit state wherein the PSD is discharging, by switching the switching modules from (S_{b}, S₀) to (S₀, S_{b}) via (S_{b}, Sₚ); and
enable the PSD to discharge, by switching the switching modules from (S₀, S_{b}) to (S_{b}, S₀) via (S_{b}, Sₚ);
wherein a first entry in each pair of brackets denotes a module state of the first switching module and a second entry in each pair of brackets denotes a module state of the second switching module.

6. The switch system of claim 5, wherein the controller is further configured to:
disable the PSD, when charging, by diverting current from the first line to the second line by switching the switching modules directly from (S_{b}, S₀) to (S₀, S_{b}); and
enable the PSD to charge, by diverting current from the second line to the first line by switching the switching modules directly from (S₀, S_{b}) to (S_{b}, S₀).

7. The switch system of claim 3, wherein the second switching module comprises a switching unit, a diode, a second switching module input, and a second switching module output;
wherein the second switching module input is positioned between the electrical input and the switching unit, adjacently to the switching unit;
wherein a third line and a fourth line extend in the EI-to-EO direction from the switching unit and converge to the second line at the second switching module output, which forms a three-way junction;
wherein the diode is mounted on the fourth line and is configured to prevent current flow in the EO-to-EI direction; and
wherein the switching unit is switchable at least between a (i) two-way conduction state M_{b}, in which the electrical input is electrically coupled to the third line via the switching unit, (ii) a one-way conduction state Mₚ, in which the electrical input is electrically coupled to the fourth line via the switching unit and electrically decoupled from the third line, and (iii) a no-conduction state M₀, in which the switching unit electrically decouples the electrical input from both the third line and the fourth line.

8. The switch system of claim 7, wherein the switching unit is or comprises a first SPST switch mounted on the third line and a second SPST switch mounted on the fourth line.

9. The switch system of claim 4, wherein the second switching module comprises a switching unit, a diode, a second switching module input, and a second switching module output;
wherein the second switching module input is positioned between the electrical input and the switching unit, adjacently to the switching unit;
wherein a third line and a fourth line extend in the EI-to-EO direction from the switching unit and converge to the second line at the second switching module output, which forms a three-way junction;
wherein the diode is mounted on the fourth line and is configured to prevent current flow in the EO-to-EI direction; and
wherein the switching unit is switchable at least between a (i) two-way conduction state M_{b}, in which the electrical input is electrically coupled to the third line via the switching unit, and (ii) a one-way conduction state Mₚ, in which the electrical input is electrically coupled to the fourth line via the switching unit and electrically decoupled from the third line.

10. The switch system of claim 9, wherein the switching unit is or comprises a SPDT switch configured to controllably electrically couple the electrical input to either the third line or the fourth line.

11. The switch system of claim 1, wherein the switch assembly comprises a first switching module and a second switching module;
wherein the first switching module is serially-connected to the PSD and is positioned together therewith on a first line extending from the EI to the EO, which corresponds to the FCP, and the second switching module is positioned on a second line extending from the EI to the EO, which corresponds to a first conduction path of the at least one ACP;
wherein a third line extends from the second switching module to the first switching module and has a mounted thereon a diode configured to prevent current flow therethrough from the first switching module to the second switching module;
wherein a line segment of the second line, which extends from the electrical input to the second switching module, the third line, and a line segment of the first line, which extends from the first switching module to the electrical output, jointly define a second conduction path of the at least one ACP; and
wherein the first switching module is switchable by the controller to a module state S_{b}′, in which current is capable of flowing via the first line both from the EI to the EO and from the EO to the EI, and to a module state S₀′, in which current flow via the first line both from the EI to the EO and from the EO to the EI is blocked; and
wherein the second switching module is switchable by the controller to a module state S_{b}″, in which current is capable of flowing via the second line both from the EI to the EO and from the EO to the EI, and a module state Sₚ″, in which current is capable of flowing from the EI to the EO but not vice-versa via the second conduction path of the at least one ACP.

12. The switch system of claim 11, wherein (i) when the first switching module is in module the S_{b}′ and the second switching module is in the module state Sₚ″, the switch assembly is in the first assembly state Q₁, (ii) when the first switching module is in the S₀′ and the second switching module is in the module state S_{b}″, the switch assembly is in the second assembly state Q₂, (iii) when the first switching module is in the module state S₀′ and the second switching module is in the module state Sₚ″, the switch assembly is in the alternative third assembly state Q₃′.

13. The switch system of claim 11, wherein the second switching module is additionally switchable to a module state S₀″, in which current flow via each of the second line, and the second conduction path of the at least one ACP, both from the EI to the EO and from the EO to the EI is blocked.

14. The switch system of claim 13, wherein (i) when the first switching module is in module the S_{b}′ and the second switching module is in the module state Sₚ″, the switch assembly is in the first assembly state Q₁, (ii) when the first switching module is in the S₀′ and the second switching module is in the module state S_{b}″, the switch assembly is in the second assembly state Q₂, (iii) when the first switching module is in the module state S_{b}′ and the second switching module is in the state S₀″, the switch assembly is in the third assembly state Q₃.

15. The switch system of claim 14, wherein the controller is further configured to:
circumvent the PSD, starting from an initial circuit state wherein the PSD is discharging, by switching the switching modules from (S_{b}′, S₀″) to (S₀′, S_{b}″) via (S_{b}′, Sₚ″); and
enable the PSD to discharge, by switching the switching modules from (S₀′, S_{b}″) to (S_{b}′, S₀″) via (S_{b}′, Sₚ″);
wherein a first entry in each pair of brackets denotes a module state of the first switching module and a second entry in each pair of brackets denotes a module state of the second switching module.

16. The switch system of claim 15, wherein the controller is further configured to:
disable the PSD, when charging, by diverting current from the first line to the second line by switching the switching modules directly from (S_{b}′, S₀″) to (S₀′, S_{b}″); and
enable the PSD to charge, by diverting current from the second line to the first line by switching the switching modules directly from (S₀′, S_{b}″) to (S_{b}′, S₀″).

17. The switch system of claim 1, wherein the PSD comprises a rechargeable battery pack.

18. The switch system of claim 1, further comprising monitoring equipment, which comprises one or more of an ammeter, a voltmeter, an ohmmeter, and/or capacitance meter;
wherein the monitoring equipment is configured to monitor a state-of-charge (SoC) and/or remaining capacity, of the PSD, and to send to the monitored SoC and/or the monitored remaining capacity, to the controller;
wherein the controller is configured to, during discharging of the PSD, instruct the switch assembly to disable the PSD when the PSD becomes depleted or sufficiently near depleted; and
wherein the controller is configured to, during charging of the PSD, instruct the switch assembly to disable the PSD when the PSD becomes saturated or sufficiently near saturated.

19. The switch system of claim 19, wherein the monitoring equipment further comprises one or more of a thermometer, configured to measure a temperature of the PSD, and/or a pressure meter, configured to measure a pressure within the PSD;
wherein the monitoring equipment is configured to send the measured temperature and/or the measured pressure to the controller; and
wherein the controller is configured to instruct the switch assembly to disable the PSD when the measured temperature exceeds a threshold temperature and/or when the measured pressure exceeds a threshold pressure.

20. A power management system (PMS) for controlling and regulating charging and discharging of an array of rechargeable PSDs, the PMS comprising a plurality of serially connectable PSDs and switch systems according to claim 1, wherein each of the switch systems is associated with a respective one of the PSDs, the PMS further comprising monitoring equipment configured to monitor at least SoCs and/or remaining capacities of the PSDs in the array, wherein the controller of each switch system is configured to switch the respective switching assembly between the respective assembly states thereof based at least on the monitored SoCs and/or remaining capacities of the respective PSD.
